(19) United States
(12) Patent Application Publication
(10) Pub. No.: US 2016/0113065 A1
(43) Pub. Date: Apr. 21, 2016

(54) ELECTRICAL HEATER

(71) Applicant: HEAT TRACE LIMITED, Helsby, Frodsham Cheshire (GB)

(72) Inventors: Jason Daniel Harold O'CONNOR, Glossop, Derbyshire (GB); Peter Richard HOWE, Warrington, Cheshire (GB); Ian James SCOTT, Hadfield, Derbyshire (GB)

(21) Appl. No.: 14/892,148

(22) PCT Filed: May 21, 2014
(86) PCT No.: PCT/GB2014/051559

§ 371 Date: Nov. 18, 2015

(30) Foreign Application Priority Data
May 21, 2013 (GB) 1309145.9
Mar. 14, 2014 (GB) 1404533.0
Mar. 14, 2014 (GB) 1404534.8

(51) Int. Cl. H05B 3/48

(52) U.S. Cl. CPC H05B 3/48

(57) ABSTRACT

An electrical heater comprising; a first conductor, a second conductor, and a heating element disposed between the first conductor and the second conductor, wherein the heating element comprises an electrically conductive material distributed within a first electrically insulating material, wherein the first electrically insulating material is an ethylene acetate or ethylene acrylate copolymer, and wherein the electrical heater comprises a stack, the first conductor, the second conductor and the heating element comprising layers of the stack.

The present invention relates to an electrical heater. The electrical heater may for example be a heating mat or a heating cable.

Parallel resistance self-regulating heating cables are well known. Such cables normally comprise two conductors (known as buswires) extending longitudinally along the cable. Typically, the conductors are embedded within a resistive polymeric heating element, the element being extruded continuously along the length of the conductors. The cable thus has a parallel resistance form, with power being applied via the two conductors to the heating element connected in parallel across the two conductors. The heating element usually has a positive temperature coefficient of resistance. Thus as the temperature of the heating element increases, the resistance of the material electrically connected between the conductors increases, thereby reducing power output. Such heating cables, in which the power output varies according to temperature, are said to be self-regulating or self-limiting.

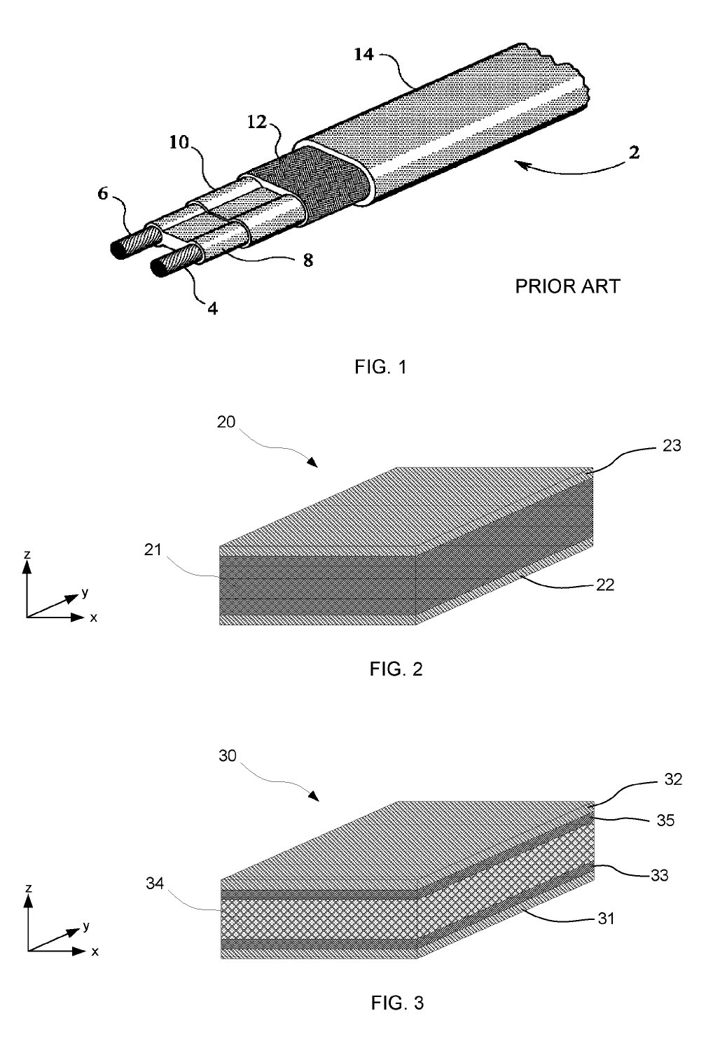

FIG. 1 illustrates a prior art parallel resistance self-regulating heating cable 2. The cable consists of a resistive polymeric heating element 8 extruded around the two parallel conductors 4, 6. A polymeric insulator jacket 10 is then extruded over the heating element 8. A conductive outer braid 12 (e.g. a tinned copper braid) is added for additional mechanical protection and/or use as an earth wire. The braid is covered by a thermo plastic overjacket 14 for additional mechanical and corrosion protection.

Such parallel resistance self-regulating heating cables possess a number of advantages over non self-regulating heating cables and are thus relatively popular. As the temperature at any particular point in the cable increases, the resistance of the heating element at that point increases, reducing the power output at that point, such that the heating cable is effectively turned down or switched off. This characteristic is known as a positive temperature coefficient of resistance (PTC). Self-regulating heating cables do not usually overheat or burn out, due to their PTC characteristics.

However, parallel resistance self-regulating heaters possess a number of undesirable characteristics.

Often, a heating cable will be used to provide freeze protection. For example, a cable may be wrapped around a fluid carrying conduit, with the aim of preventing the fluid carried by the conduit from freezing. In such a case, heat may be required to raise the temperature from below freezing (e.g. 0° C.) to a temperature of around +20° C. However, most heating cables provide self-regulation at around +75° C. or above. Therefore, any energy used to raise the temperature from +20° C. to +75° C. is wasted.

It is an object of the present invention to provide an electrical heater that obviates or mitigates one or more of the problems of the prior art, whether referred to above or otherwise.

According to a first aspect of the present invention there is provided an electrical heater comprising: a first conductor, a second conductor, and a heating element disposed between the first conductor and the second conductor, wherein the heating element comprises an electrically conductive material distributed within a first electrically insulating material, wherein the first electrically insulating material is an ethylene acetate or ethylene acrylate copolymer, and wherein the electrical heater comprises a stack, the first conductor, the second conductor and the heating element comprising layers of the stack.

For brevity, the term ethylene acetate/acrylate copolymers may be used herein instead of referring to ethylene acetate or ethylene acrylate copolymers.

The heating element is referred to above as comprising an electrically conductive material distributed within an ethylene acetate or ethylene acrylate copolymer. The combination of ethylene acetate or ethylene acrylate copolymers and electrically conductive materials may be referred to as an ethylene acetate or an ethylene acrylate compound respectively. The term ethylene acetate/acrylate compounds may be used herein instead of referring to ethylene acetate or ethylene acrylate compounds. In the context of their use within ethylene acetate/acrylate compounds, electrically conductive materials may be referred to as conductive fillers.

The term ethylene acetate/acrylate element may be used herein instead of referring to an element comprising ethylene acetate/acrylate compounds. This terminology is not, however, intended to exclude the presence of other materials within the ethylene acetate/acrylate element. For instance, an ethylene acetate/acrylate element may further comprise another polymer, such as high density polyethylene.

The ethylene acetate or ethylene acrylate copolymer may have a gel content of greater than 60% by weight.

The first conductor and the second conductor may be formed from metal foils.

Each layer of the stack may have a substantially uniform thickness.

The ethylene acetate or ethylene acrylate copolymer may have been irradiated with an electron beam such that the ethylene acetate or ethylene acrylate is cross-linked.

The ethylene acetate or ethylene acrylate copolymer may have a gel content of between 75% and 85% by weight.

The ethylene acetate or ethylene acrylate copolymer may be ethylene methyl-acrylate, ethylene ethyl-acrylate or ethylene vinyl-acetate.

The electrically conductive material may comprise conductive particles.

The conductive particles may be selected from carbon black, graphite, graphene, carbon fibres, carbon nanotubes, metal powders, metal strand or metal coated fibre.

The heating element may further comprise a second electrically insulating material.

The second electrically insulating material may be high density polyethylene, medium density polyethylene, low density polyethylene, linear low density polyethylene, polypropylene, polyamide or polyesters. Alternatively, the polymer may be a fluoropolymer selected from PFA (copolymer of tetrafluoroethylene and perfluoropropyl vinyl ether), MFA (copolymer of tetrafluoroethylene and perfluoromethylvinylether), FEP (copolymer of tetrafluoroethylene and hexafluoropropylene), ETFE (copolymer of ethylene and tetrafluoroethylene) or PVDF (polyvinylidene fluoride). The polymer may be a blend of two or more polymers.

The heating element may be arranged to operate as a temperature regulation element.

According to a second aspect of the invention there is provided an electrical heater comprising; a first conductor, a second conductor, a first element, the first element comprising a first electrically conductive material distributed within an ethylene acetate or ethylene acrylate copolymer, and a heating element, the heating element comprising a second electrically conductive material distributed within an electrically insulative material, wherein; the first element is disposed between the first conductor and heating element, and the heating element is disposed between the first element and the second conductor, wherein the electrical heater comprises a stack, the first conductor, the second conductor and the heating element comprising layers of the stack.

The first conductor and the second conductor may be formed from metal foils.

Each layer of the stack may have a substantially uniform thickness.

The ethylene acetate or ethylene acrylate copolymer may be ethylene methyl-acrylate, ethylene ethyl-acrylate or ethylene vinyl-acetate.

The first electrically conductive material may comprise conductive particles.

The second electrically conductive material may comprise conductive particles.

The conductive particles may be selected from carbon black, graphite, graphene, carbon fibres, carbon nanotubes, metal powders, metal strand or metal coated fibre.

The first element may be arranged to operate as a temperature regulation element.

The first element may have a positive temperature coefficient of resistance.

The ethylene acetate or ethylene acrylate copolymer may have a gel content of greater than 60% by weight.

The ethylene acetate or ethylene acrylate copolymer may have been irradiated with an electron beam such that the ethylene acetate or ethylene acrylate is cross-linked.

The ethylene acetate or ethylene acrylate copolymer may have a gel content of between 75% and 85% by weight.

The first element may be arranged to operate as an adhesion element.

The heating element may be arranged to operate as a temperature regulation element.

The heating element may have a positive temperature coefficient of resistance.

The electrically insulative material may comprise a polymer.

The polymer may be high density polyethylene, medium density polyethylene, low density polyethylene, linear low density polyethylene, polypropylene, polyamide or polyesters. Alternatively, the polymer may be a fluoropolymer selected from PFA (copolymer of tetrafluoroethylene and perfluoropropyl vinyl ether), MFA (copolymer of tetrafluoroethylene and perfluoromethylvinylether), FEP (copolymer of tetrafluoroethylene and hexafluoropropylene), ETFE (copolymer of ethylene and tetrafluoroethylene) or PVDF (polyvinylidene fluoride). The polymer may be a blend of two or more polymers.

The electrical heater may further comprise; a second element, wherein the second element comprises a third electrically conductive material distributed within a second ethylene acetate or ethylene acrylate copolymer, and wherein the second element is disposed between the heating element and the second conductor.

The second element may be arranged to operate as a temperature regulation element.

The second element may be arranged to operate as an adhesion element.

The first element may have a first positive temperature coefficient of resistance and the second element may have a second positive temperature coefficient of resistance.

The electrical heater may extend in a first direction to a significantly lesser extent than in a second direction, the first direction being perpendicular to the second direction, and the second direction being along a length of the electrical heater.

Each layer of the stack may lie substantially parallel to a plane.

The electrical heater may extend in a first direction parallel to the plane to a significantly lesser extent than in a second direction parallel to the plane, the first direction being perpendicular to the second direction.

The first conductor and/or the second conductor may have a cross sectional area in a plane normal to a length of the electrical heater of at least 10 mm².

The heating element may have a first thickness in a first region and a different thickness in a second region.

The first element may have a first thickness in a first region and a different thickness in a second region.

The electrical heater may perform a mechanical function.

The electrical heater may comprise a fluid carrying conduit.

The electrical heater may be arranged to receive a fluid carrying conduit.

The second element may have a first thickness in a first region and a different thickness in a second region.

According to a third aspect of the invention there is provided an electrical heater comprising; a first conductor, a second conductor, and a heating element, wherein the heating element comprises an electrically conductive material distributed within an ethylene acetate or ethylene acrylate copolymer, and wherein: the heating element is disposed between the first conductor and the second conductor, the first conductor, the second conductor and the heating element form a stack, and the heating element has a first thickness in a first region and a different thickness in a second region.

The electrical heater may perform a mechanical function.

The electrical heater may comprise a fluid carrying conduit.

The electrical heater may be arranged to receive a fluid carrying conduit.

According to a fourth aspect of the invention there is provided a method of manufacturing an electrical heater, the electrical heater comprising a first conductor, an ethylene acetate or ethylene acrylate compound, and a second conductor arranged in a stack, the ethylene acetate or ethylene acrylate compound comprising an electrically conductive material distributed within an ethylene acetate or ethylene acrylate copolymer and being disposed between the first conductor and the second conductor, the method comprising; raising the temperature of the ethylene acetate or ethylene acrylate compound so as to melt the ethylene acetate or ethylene acrylate compound; applying force to the first conductor and the ethylene acetate or ethylene acrylate compound so as to force substantially all of the air from between the first conductor and the ethylene acetate or ethylene acrylate compound and from within the ethylene acetate or ethylene acrylate compound; and cooling the ethylene acetate or ethylene acrylate compound to ambient temperature such that, when cooled, the ethylene acetate or ethylene acrylate compound is arranged to form an ethylene acetate or ethylene acrylate element and is bonded to the first conductor.

The method may further comprise: providing a heating element compound, the heating element compound comprising a second electrically conductive material distributed within an electrically insulating material, wherein the heating element compound is disposed between the second conductor and the ethylene acetate or ethylene acrylate element, raising the temperature of the heating element compound so as to melt the heating element compound; applying force to the ethylene acetate or ethylene acrylate compound and the heating element compound so as to force substantially all of the air from between the ethylene acetate or ethylene acrylate compound and the heating element compound and from within the heating element compound; and cooling the heating element compound to a temperature below the melting point of the heating element compound such that, when cooled, the heating element compound is arranged to form a heating element.

The method may further comprise: providing a second ethylene acetate or ethylene acrylate compound, the second ethylene acetate or ethylene acrylate compound comprising an third electrically conductive material distributed within a second ethylene acetate or ethylene acrylate copolymer; wherein the second ethylene acetate or ethylene acrylate compound is disposed between the heating element compound and the second conductor; raising the temperature of the second ethylene acetate or ethylene acrylate compound so as to melt the second ethylene acetate or ethylene acrylate compound; applying force to the heating element compound, the second ethylene acetate or ethylene acrylate compound, and the second conductor so as to force substantially all of the air from between the heating element compound and the second ethylene acetate or ethylene acrylate compound, and the second ethylene acetate or ethylene acrylate compound and the second conductor and from within the second ethylene acetate or ethylene acrylate compound; and cooling the second ethylene acetate or ethylene acrylate compound to a temperature below the melting point of the second ethylene acetate or ethylene acrylate compound such that, when cooled, the second ethylene acetate or ethylene acrylate compound is arranged to form a second ethylene acetate or ethylene acrylate element and is bonded to the second conductor.

The method may be a continuous process.

Force may be applied at least partially by extrusion through a die.

Force may be applied at least partially by rollers.

Applying force to the first conductor and the ethylene acetate or ethylene acrylate compound may comprise: applying a first force to the ethylene acetate or ethylene acrylate compound so as to force substantially all of the air from within the ethylene acetate or ethylene acrylate compound; and applying a second force to the first conductor and the ethylene acetate or ethylene acrylate compound so as to force substantially all of the air from between the first conductor and the ethylene acetate or ethylene acrylate compound.

The first and second forces may be applied sequentially. The first and second forces may be applied simultaneously.

The first force may be applied by extrusion through a die.

The second force may be applied by rollers.

The method may further comprise irradiating the ethylene acetate or ethylene acrylate compound with an electron beam.

The electrical heater may be irradiated with a dosage of at least 50 kilograys of electron beam radiation.

According to a fifth aspect of the invention there is provided a method of manufacturing an electrical heater, the electrical heater comprising a first conductor, an ethylene acetate or ethylene acrylate compound, and a second conductor arranged in a stack, the ethylene acetate or ethylene acrylate compound comprising an electrically conductive material distributed within an ethylene acetate or ethylene acrylate copolymer and being disposed between the first conductor and the second conductor, the method comprising; raising the temperature of the ethylene acetate or ethylene acrylate compound so as to melt the ethylene acetate or ethylene acrylate compound; applying force to the first conductor, the second conductor, and the ethylene acetate or ethylene acrylate compound so as to force substantially all of the air from between the first conductor and the ethylene acetate or ethylene acrylate compound, and the ethylene acetate or ethylene acrylate compound and the second conductor and from within the ethylene acetate or ethylene acrylate compound; and cooling the ethylene acetate or ethylene acrylate compound to ambient temperature such that, when cooled, the ethylene acetate or ethylene acrylate compound is arranged to form an ethylene acetate or ethylene acrylate element and is bonded to the first conductor and the second conductor.

According to a sixth aspect of the invention there is provided a method of manufacturing an electrical heater, the electrical heater comprising a first conductor, an ethylene acetate or ethylene acrylate compound, a heating element compound, and a second conductor arranged in a stack, the ethylene acetate or ethylene acrylate compound comprising an electrically conductive material distributed within an ethylene acetate or ethylene acrylate copolymer and being disposed between the first conductor and the heating element compound, the heating element compound comprising a second electrically conductive material distributed within an electrically insulating material, wherein the heating element compound is disposed between the ethylene acetate or ethylene acrylate compound and the second conductor, the method comprising; raising the temperature of the ethylene acetate or ethylene acrylate compound and the heating element compound so as to melt the ethylene acetate or ethylene acrylate compound and the heating element compound; applying force to the first conductor, the second conductor, the ethylene acetate or ethylene acrylate compound and the heating element compound so as to force substantially all of the air from between the first conductor and the ethylene acetate or ethylene acrylate compound, the ethylene acetate or ethylene acrylate compound and the heating element compound, and the heating element compound and the second conductor, and from within the ethylene acetate or ethylene acrylate compound and the heating element compound; and cooling the ethylene acetate or ethylene acrylate compound and the heating element compound to ambient temperature such that, when cooled, the ethylene acetate or ethylene acrylate compound is arranged to form an ethylene acetate or ethylene acrylate element which is bonded to the first conductor and the heating element compound is arranged to form a heating element which is bonded to the second conductor.

Any of the features of the first to fourth aspects of the invention may be combined with the fifth and sixth aspects. For example, the materials described with reference to the first and second aspects, and the methods described with reference to the fourth aspect, may be applied to the fifth and sixth aspects of the invention.

According to a seventh aspect of the invention, there is provided an electrical heater manufactured according to the fourth, fifth or sixth aspects of the invention.

According to an eighth aspect of the invention, there is provided an electrical heater comprising a first conductor which extends along a length of the electrical heater, a heating element disposed around the first conductor and along the length of the electrical heater; and a second conductor disposed around the heating element and along the length of the electrical heater; wherein the heating element comprises an electrically conductive material distributed within an electrically insulating material, and the electrically insulating material is an ethylene acetate or ethylene acrylate copolymer.

The arrangement of an electrical heater in which the heating element is disposed around the first conductor, and in which the second conductor is disposed around both the heating element and the first conductor, allows the electrical heater to be bent in any direction. This mechanical flexibility allows the electrical heater to be used in a large number of different applications. For example, the electrical heater can be wound around oil pipelines without having to be oriented in a preferred bending direction.

The ethylene acetate or ethylene acrylate copolymer may have a gel content of greater than 60% by weight.

The first conductor and/or the second conductor may have a cross sectional area in a plane normal to the length of the electrical heater of at least 10 mm². The cross sectional area of the first and/or second conductor is preferably at least 20 mm². The cross sectional area of the first and/or second conductor is more preferably approximately 40 mm².

The larger the cross sectional area of the conductors in an electrical heater, the smaller the voltage drop along the conductors when a current is passed along them in use. The use of a conductor having an increased cross sectional area therefore provides an advantage over smaller cross sectional area conductors by enabling an electrical heater to extend for a greater length.

Any of the features of the first to seventh aspects of the invention may be combined with the eighth aspect. For example, the materials described with reference to the first and second aspects, and the methods described with reference to the fourth, fifth and sixth aspects, may be applied to the eighth aspect of the invention.

More generally, it will be appreciated that where features are discussed in the context of one aspect they may be applied to other aspects.

Embodiments of the present invention will now be described, by way of example, with reference to the accompanying drawings, in which:

FIG. 1 is a partially cut away perspective view of a prior art parallel resistance self-regulating heating cable;

FIG. 2 is a perspective view of an electrical heater in accordance with an embodiment of the present invention;

FIG. 3 is a perspective view of an electrical heater in accordance with an alternative embodiment of the present invention;

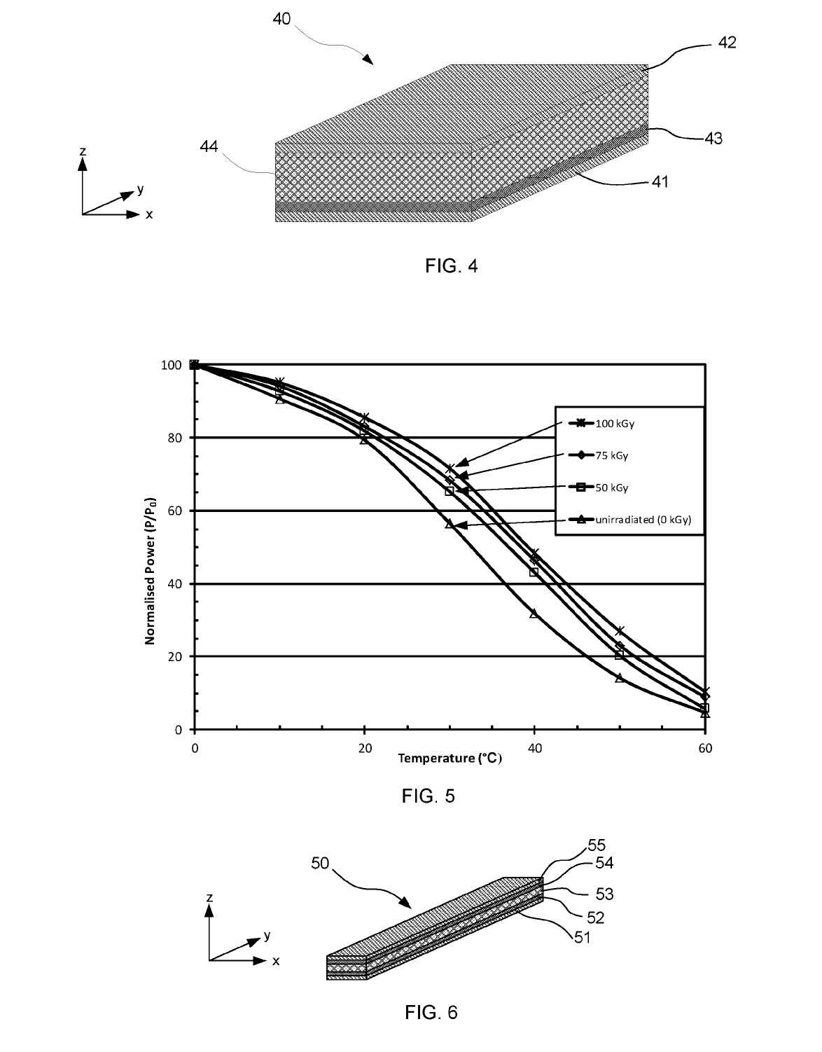

FIG. 4 is a perspective view of an electrical heater in accordance with an alternative embodiment of the present invention;

FIG. 5 is graph showing temperature-power characteristics of various electrical heaters made in accordance with embodiments of the present invention;

FIG. 6 is a perspective view of an electrical heater in accordance with an alternative embodiment of the present invention;

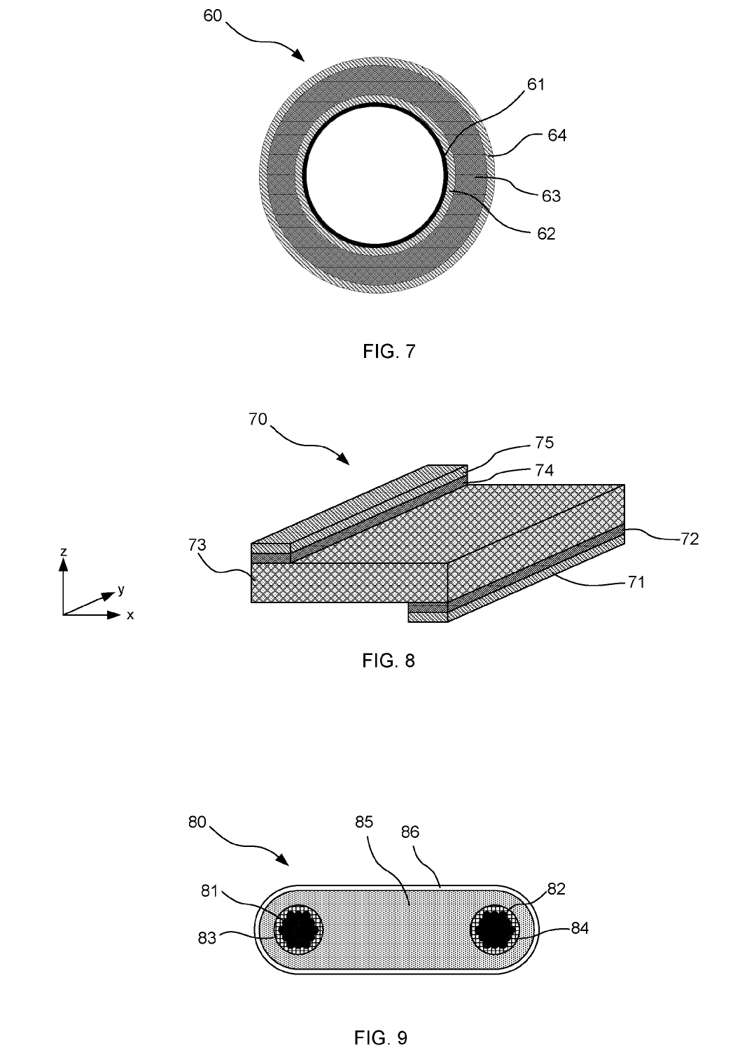

FIG. 7 is an end-on view of an electrical heater in accordance with an alternative embodiment of the present invention;

FIG. 8 is a perspective view of an electrical heater in accordance with an alternative embodiment of the present invention;

FIG. 9 is an end-on view of an electrical heater in accordance with an alternative embodiment of the present invention;

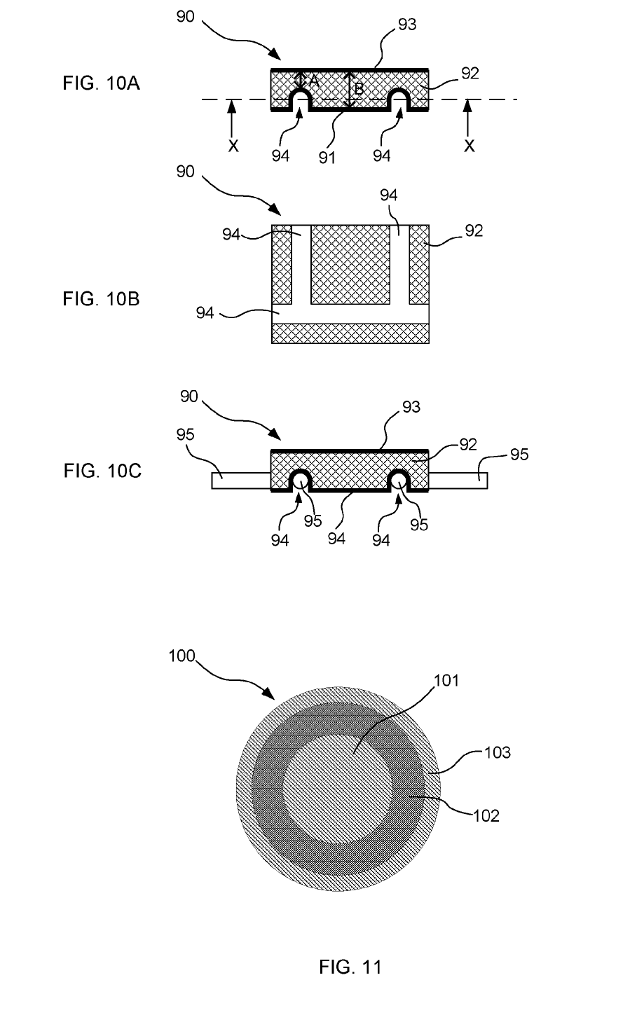

FIGS. 10A-C show a plan view, and side elevations of an electrical heater in accordance with an alternative embodiment of the present invention; and

FIG. 11 is an end-on view of an electrical heater in accordance with an alternative embodiment of the present invention.

FIG. 2 illustrates schematically a self-regulating electrical heater 20 in accordance with an embodiment of the present invention. The electrical heater 20 may be a heating mat. The electrical heater 20 comprises a stack of elements. An ethylene acetate/acrylate element 21 extends throughout the centre of the electrical heater 20.

The ethylene acetate/acrylate element 21 is sheet-like in form, having a substantially uniform thickness. The ethylene acetate/acrylate element 21 extends in a first dimension x and a second dimension y to a significantly greater extent than the thickness, which is in the third dimension z. The ethylene acetate/acrylate element 21 has a positive temperature coefficient, such that resistance of the element 21 increases with temperature.

The ethylene acetate/acrylate element 21 comprises a conductive filler distributed within a matrix of an insulative material. The insulative material is an ethylene-acrylate or an ethylene-acetate copolymer. An ethylene-acrylate copolymer may be a copolymer of ethylene and ethyl-acrylate (ethylene ethyl-acrylate). Alternatively the ethylene-acrylate copolymer may be a copolymer of ethylene and methyl-acrylate (ethylene methyl-acrylate). Alternatively, the insulative material may be a copolymer of ethylene and vinyl-acetate (ethylene vinyl-acetate). These materials will be referred to as ethylene acetate or ethylene acrylate copolymers, or, for brevity, ethylene acetate/acrylate copolymers.

The conductive filler may be conductive particles. The conductive particles may be particles of carbon black. The combination of ethylene acetate or ethylene acrylate copolymers and conductive fillers may be referred to as an ethylene acetate or ethylene acrylate compounds respectively. The term ethylene acetate/acrylate compounds may be used herein instead of referring to ethylene acetate or ethylene acrylate compounds. An ethylene acetate/acrylate element may, in different embodiments, perform one or more functions within the electrical heater. For example, an ethylene acetate/acrylate element may function as a temperature regulation element, a heating element, or an adhesion element. These are all examples of elements. Therefore, an element within an electrical heater which comprises an ethylene acetate/acrylate compound may be referred to as an ethylene acetate/acrylate element, or, for brevity, as an element.

The ethylene acetate/acrylate element 21 may be formed from a number of other suitable materials. Table 1 lists example ranges and example materials which may be suitable for use to form the ethylene acetate/acrylate element 21. Any one or more of the listed materials could be utilised, from any one or more of the listed types.

TABLE 1
Ethylene acetate/acrylate Element: Range of Formulations

| | | Addition |
|---|---|---|
| Type | Compounds could include but not be limited to | Range |
| Conductive | Carbon Black | 2%-45% |
| | Graphite | |
| | Graphene | |
| | Carbon fibre | |
| | Nanotubes | |
| | Metal Powders | |
| | Metal strand | |
| | Metal coated fibre | |
| Insulative | Ethylene Acetate/Acrylate Copolymers | 55%-98% |
| | EMA: Ethylene methyl acrylate | |
| | EEA: Ethylene ethyl acrylate | |
| | EBA: Ethylene butyl acrylate | |
| | EVA: Ethylene vinyl acetate | |

The ethylene acetate/acrylate element 21 is sandwiched between a first conductor 22 and a second conductor 23. The first and second conductors 22, 23 are formed of a metal foil. The metal foil may be made from any suitable metal, such as, for example, aluminium. The first and second conductors 22, 23 are fixed to opposite sides of the ethylene acetate/acrylate element 21.

The term “metal foil” is intended to mean any sheet-like form of metal. However, it will be appreciated that while a foil is usually continuous, it may also be discontinuous. For example, a foil may comprise a sheet of metal containing a plurality of apertures. A metal foil may have a thickness of, for example, around 0.15 mm. A metal foil may, for example, have a thickness of up to around 0.5 mm.

In use ethylene acetate/acrylate element 21 operates as a heating element. The ethylene acetate/acrylate element 21 may further operate as a temperature regulation element. The electrical heater 20 may have low temperature self-regulating characteristics by virtue of the positive temperature coefficient of resistance (PTC) characteristic of the ethylene acetate/acrylate element 21. At normal operational temperatures (i.e. below the self-regulating temperature of the electrical heater 20) the ethylene acetate/acrylate element 21 will have a first electrical resistance. A voltage applied between the first and second conductors 22, 23 will cause current to flow through the ethylene acetate/acrylate element 21. The ethylene acetate/acrylate element 21 will deliver heat by converting electrical energy supplied as current through the conductors 22, 23 to thermal energy, through resistive heating. However, as the temperature approaches the self-regulating temperature, the resistance of the ethylene acetate/acrylate element 21 will rise to a second resistance which is greater than the first resistance. The increased resistance between the conductors 22, 23 causes the current flowing through the electrical heater 20 to be reduced, reducing the amount of thermal energy produced by the ethylene acetate/acrylate element 21.

FIG. 3 shows an alternative embodiment of an electrical heater 30 in which the electrical heater 30 comprises a first conductor 31, a second conductor 32, a first ethylene acetate/acrylate element 33, a second ethylene acetate/acrylate element 35 and a heating element 34. The electrical heater 30 may be a heating mat.

The heating element 34 is sandwiched between the first ethylene acetate/acrylate element 33 and the second ethylene acetate/acrylate element 35. The heating element 34, the second ethylene acetate/acrylate element 35 and the first ethylene acetate/acrylate element 33 are of similar dimensions to each other. The first and second ethylene acetate/acrylate elements 33, 35 are in contact with opposite surfaces of the heating element 34. The first and second ethylene acetate/acrylate elements 33, 35 comprise an ethylene acetate/acrylate compound. For example, an ethylene acetate/acrylate copolymer, such as ethylene ethyl-acrylate, blended with a conductive filler, such as carbon black.

The heating element 34 comprises a conductive filler distributed within a matrix of an insulative material. The insulative material may be a polymer such as high density polyethylene (HDPE). The conductive filler may be conductive particles. The conductive particles may be particles of carbon black. Alternatively, the conductive particles may be other conductive materials such as carbon fibres or carbon nanotubes, or a combination of different components. The combination of a high density polyethylene and a conductive filler may be referred to as a high density polyethylene compound (HDPE compound).

The heating element 34 may be formed from a number of other suitable materials. Table 2 lists example ranges and example materials which may be suitable for use to form the heating element 34. Any one or more of the listed materials could be utilised, from any one or more of the listed types.

TABLE 2
Heating Element: Range of Formulations

| | | Addition |
|---|---|---|
| Type | Compounds could include but not be limited to | Range |
| Conductive | Carbon Black | 2%-45% |
| | Graphite | |
| | Graphene | |
| | Carbon fibre | |
| | Nanotubes | |
| | Metal Powders | |
| | Metal strand | |
| | Metal coated fibre | |
| Insulative | HDPE: High Density Polyethylene | 55%-98% |
| | MDPE: Medium Density Polyethylene | |
| | LDPE: Low Density Polyethylene | |
| | LLDPE: Linear Low Density Polyethylene | |
| | Fluoropolymers | |
| | PFA: Copolymer of Tetrafluoroethylene | |
| | and Perfluoropropyl vinyl ether | |
| | MFA: Copolymer of Tetrafluoroethylene | |
| | and Perfluoromethylvinylether | |
| | FEP: Copolymer of Tetrafluoroethylene | |
| | and Hexafluoropropylene | |
| | ETFE: Copolymer of Ethylene and | |
| | Tetrafluoroethylene | |
| | PVDF: Polyvinylidene fluoride | |
| | Other Polymers | |
| | PP: Polypropylene | |
| | PA: Polyamide | |
| | Polyesters | |

As shown in FIG. 3, the electrical heater 30 is formed as a stack, the stack comprising the first conductor 31, the first ethylene acetate/acrylate element 33, the heating element 34, the second ethylene acetate/acrylate element 35 and the second conductor 32. The first and second conductors 31, 32 are formed of a metal foil. The metal foil may be made from any suitable metal, such as, for example, aluminium. The first and second conductors 31, 32 are fixed to the first and second ethylene acetate/acrylate elements 33, 35 respectively.

In use the heating element 34 generates heat within the electrical heater. At normal operational temperatures (i.e. below the self-regulating temperature of the electrical heater 30) the heating element 34 will deliver heat by converting electrical energy supplied as current through the conductors to thermal energy, through resistive heating. At these temperatures (i.e. below the self-regulating temperature of the electrical) the ethylene acetate/acrylate elements 33, 35 have a first resistance. However, as the temperature approaches the self-regulating temperature, the resistance of the ethylene acetate/acrylate elements 33, 35 will rise significantly. The increased total resistance between the conductors 31, 32 causes the current flowing through the electrical heater 30 to be reduced, reducing the amount of thermal energy produced by the heating element 34.

The use of a separate heating element 34 and ethylene acetate/acrylate elements 33, 35 is considered optional in electrical heaters according to some embodiments of the invention. The electrical heater in FIG. 2 is shown without a separate heating element and only a single ethylene acetate/acrylate element 21, while the electrical heater in FIG. 3 is shown with a separate heating element 34 and two ethylene acetate/acrylate elements 33, 35.

In an embodiment an electrical heater may comprise two conductors, an ethylene acetate/acrylate element and a heating element (the heating element comprising e.g. an HDPE compound). In such an embodiment the ethylene acetate/acrylate element may function as a temperature regulation element, while the heating element may function as a heating element. For example, an electrical heater 40, as shown in FIG. 4, comprises a first conductor 41, a second conductor 42, an ethylene acetate/acrylate element 43 and a heating element 44. The electrical heater 40 is formed as a stack, the stack comprising the first conductor 41, the ethylene acetate/acrylate element 43, the heating element 44 and the second conductor 42. The first and second conductors 41, 42 are formed of a metal foil. The metal foil may be made from any suitable metal, such as, for example, aluminium. The first conductor 41 is fixed to the ethylene acetate/acrylate element 43, and the heating element 44 is provided between the ethylene acetate/acrylate element 43 and the second conductor 42. It will be appreciated that in such an embodiment, an adequate bond should be formed between the heating element 44 and the second conductor 42. As described in more detail below, appropriate materials and processing steps should be used to form the heating element 44 so as to provide an adequate bond to the second conductor 42.

It will be appreciated that an electrical heater may be made in accordance with any of the described embodiments of the invention with or without a separate heating element.

In general, an electrical heater has at least one heating element. Further, for an electrical heater to perform as a self-regulating electrical heater it should comprise at least one element which can function as a temperature regulation element. The functions of heating element and temperature regulation element may be performed by the same element or by different elements.

A failure mode of prior art parallel resistance self-regulating heating cables is loss of, or reduction in, electrical contact between the power conductors and the extruded resistive matrix forming the heating element. For example, differential expansion of the components and thermal cycling may lead to such failure or reduction in electrical contact over time. This problem is exacerbated by the materials which are commonly used. High Density Polyethylene (HDPE) is frequently used as a matrix for the resistive heating part, while copper is commonly used to form the conductors. However, it has been found that HDPE does not adhere well to the copper conductors, leading to a high likelihood of the electrical contact being reduced. Such a reduction in electrical contact may lead to electrical arcing within the cable, and a consequent loss in thermal output. The operational life of the electrical heater may thus be dependent upon the bond between the conductors and the heating element.

The use of an ethylene acetate/acrylate element between the conductors and a heating element formed from a HDPE compound provides an advantage over prior art heating cables. The ethylene acetate/acrylate element forms strong bonds with both the conductors and the heating element, ensuring that a good electrical contact is maintained, thereby prolonging the life-time of the electrical heater. In addition to, or instead of, functioning as a temperature regulation element and/or a heating element, an ethylene acetate/acrylate element may function as and be referred to as an adhesion element.

The different elements an electrical heater may perform different functions in different arrangements. For example, in the electrical heater shown in FIG. 2, the ethylene acetate/acrylate element 21 is a heating element and a temperature regulation element. In the electrical heater shown in FIG. 3 the ethylene acetate/acrylate elements 33, 35 function as temperature regulation elements and adhesion elements, with the heating element 34 functioning as a heating element. In an alternative configuration, the ethylene acetate/acrylate elements 33, 35 of electrical heater 30 may function only as adhesion elements, with the heating element 34 functioning as both a heating element and a temperature regulation element.

The use of ethylene acetate/acrylate elements as temperature regulation elements in electrical heaters may provide an advantageously low self-regulating temperature, when compared to an electrical heater having a temperature regulation element comprising, for example, an HDPE compound.

A process by which electrical heaters according to embodiments of the invention such as those shown in FIGS. 2, 3 and 4 may be formed will now be described. The process is described with reference to the electrical heater 30 shown in FIG. 3, comprising a separate heating element 34. However, a similar process may be followed to fabricate an electrical heater 20 as shown in FIG. 2, with the omission of unnecessary steps relating to the formation of the heating element 34. Equally, the process steps described, where appropriate, could be applied to the fabrication of the electrical heater 40 as shown in FIG. 4.

The electrical heater 30 is formed using a press, which is arranged to apply variable force to a workpiece, while also maintaining the workpiece at a controlled temperature. The controlled temperature may be an elevated temperature. The material for forming the work-piece is loaded into the press within a mould. The mould comprises a void of a predetermined volume, with dimensions which define the shape of the finished work-piece. The mould further comprises plates which define the upper and lower boundaries of the void, and which make contact with the work-piece during the pressing procedure. The void of the mould is sized appropriately depending on the intended final dimensions of the electrical heater 30.

A quantity of pre-mixed material for forming the heating element 34 is placed into a mould designed for the purpose of creating the heating element 34. The pre-mixed material may be in the form of pellets. The pre-mixed material is a HDPE based self-regulating compound, which comprises HDPE blended with a conductive filler such as particles of carbon black. The HDPE based self-regulating compound will be referred to the HDPE compound.

The mould, having been filled with the HPDE compound, is inserted into the press. An initial force is then applied to the mould, and maintained as the press is heated to a temperature above the melting temperature of the HDPE compound. HDPE has a melting point of around 130° C. However, it will be appreciated that the melting point of the HPDE compound may differ from that of the pure material. The temperature of the press is kept below the thermal degradation temperature of HDPE. The thermal degradation temperature of HDPE may be around 220° C. A temperature of a between 140° C. and 210° C. may be selected as a target temperature to melt the HDPE compound. Appropriate processing temperatures for a particular material or material blend can be determined from the melting point and degradation temperatures of that material or material blend.

The application of the initial force ensures that the pellets of HDPE compound are evenly distributed within the press. The initial force should be sufficient to ensure that the HDPE compound is in good contact with both the bottom and top plates of the press, rather than just the bottom plate. This allows the HDPE compound to be melted by both the top and bottom plates. A force of 10 kN is suitable as the initial force when applied to a mould containing HDPE compound having dimensions of 100 mm×200 mm. Once the target temperature has been reached, the initial force is maintained for a period sufficient to ensure that all of the HDPE compound is melted. A period of 5 minutes is sufficient to allow the HDPE compound to have fully melted.

The above mentioned values of force, temperature, and period of time of the initial pressing process are selected to cause the HDPE compound to melt. Any parameter may be adjusted provided that the stated aim, of causing the HDPE compound to melt, is achieved. For example, while evenly melting the HDPE material from both bottom and top plates may be desirable, it is not essential. The application of pressure may be omitted, with the period for which the HDPE material is held at a raised temperature being increased accordingly.

The application of any force will depend upon the area over which the force is applied. The pressure applied to the HDPE material should be selected to achieve the intended outcome. The force is then calculated based on the area of the HDPE compound mould and the pressure which is to be applied.

Once the initial pressing has caused the HDPE compound to melt, the force applied by the press is increased to a higher force, exerting a higher pressure on the HDPE compound, causing air to be expelled from the HDPE compound. The higher force is applied for a period of time, while the temperature is maintained at a level sufficient to keep the HDPE compound in molten form. The higher force and time period for which it is applied are chosen to ensure that substantially all air has been expelled from the HDPE compound. A force of 200 kN is suitable when applied to a HDPE compound mould with dimensions of 100 mm×200 mm. A period of 5 minutes is sufficient to cause substantially all of the air within the HDPE compound to be expelled, when combined with a force of 200 kN.

Once the HDPE compound has been melted, and substantially all of the air expelled, the press is then rapidly cooled. Cooling may be brought about by any convenient mechanism. For example, cooling water channels within the press plates can be provided with chilled water from a water chiller. Depending on the temperature of the plates, as water is provided to the cooling water channels it may be heated rapidly, causing the water to boil, generating steam. The rapid expansion of steam may be accommodated in such a system by an appropriately sized and reinforced expansion tank. The heat carried away from the press plates by the water causes the temperature of the plates, and also the pressed HPDE compound to be reduced. Chilled water may be provided to the press plates continuously, until a satisfactory press temperature is reached.

The temperature is brought below the melting point of the HDPE compound. The temperature is also brought below any temperature at which any significant deformation or crystallisation can occur. This ensures that properties of the HPDE compound are stable. Cooling from around 150° C. to around 35° C. may be achieved in a time of 10 to 15 minutes by the above method. The rate of cooling is a function of the cooling capacity of the water provided, the initial temperature of the press, and the size (and therefore thermal mass) of the press. Suitable modifications to the procedure can be made to achieve a particular cooling rate. For example, if a slow cooling rate is required, it may be desirable to allow the press to cool naturally. Alternatively, if an even slower cooling rate was required, the heat supplied to the press could be gradually reduced, so as to slow the cooling rate further still.

The rate of cooling has a significant effect on the properties of the HPDE compound within a heating element part which is pressed according to the above described method. For example, the degree of crystallinity in the HDPE compound is controlled to a large extent by the cooling speed. A rapid cooling rate causes a low degree of crystallinity, whereas a slow cooling rate causes a highly crystalline material to form.

The degree of crystallinity in turn has a significant effect on the self-regulating properties of the HDPE compound and consequently the heating element part. A high degree of crystallinity within the HDPE compound results in a more fixed structure, and a low coefficient of thermal expansion within the material. Conversely, a low degree of crystallinity (i.e. a more amorphous structure) within the HDPE compound results in a less fixed structure, and a higher coefficient of thermal expansion.

Any change in thermal expansion can be related to self-regulating behaviour. For example, a large thermal expansion coefficient for the HDPE compound, resulting from a low degree of crystallinity, will result in a material with a strong self-regulation behaviour. This is because as the temperature of the material is increased, the thermal expansion in the HDPE will cause the conductive filler particles to be moved further apart within the HDPE matrix. By increasing the distance between adjacent conductive particles, the conductive pathways within the HDPE compound are made less conductive, and the resistance of the HDPE compound is increased.

On the other hand, in a more crystalline material there will be less freedom within the material for thermal expansion. For this reason, a more crystalline material will have a lower degree of thermal expansion than a less crystalline material, and consequently a less pronounced self-regulating behaviour.

Once the HDPE compound is cooled, the pressing force is removed, and the mould is removed from the press. The pressed heating element part is then removed from the mould. This heating element part forms the heating element 34.

The ethylene acetate/acrylate elements 33, 35 and conductors 31, 32 are formed in a separate process from the heating element 34. A quantity of pre-mixed material for forming the ethylene acetate/acrylate elements 33, 35 is placed in to the mould of a press, the pre-mixed material being in the form of pellets. The mould used for the ethylene acetate/acrylate elements 33, 35 has one surface lined with a nickel plate, so as to prevent the ethylene acetate/acrylate elements 33, 35 from sticking to the mould. The ethylene acetate/acrylate element mould has a void with similar major dimensions to the heating element mould. The thickness of the ethylene acetate/acrylate element 33, 35 may be selected to deliver a particular self-regulating behaviour. The pre-mixed material is an ethylene acetate/acrylate copolymer blended with a conductive filler.

The blended material will be referred to as the ethylene acetate/acrylate compound. The conductive filler is carbon black. The proportion of carbon black in the ethylene acetate/acrylate compound may be selected to bring about a particular degree of conductivity or degree of self-regulation within the ethylene acetate/acrylate element. For example, a blend with 35% by weight of carbon black particles will yield a highly conductive ethylene acetate/acrylate element 33, 35.

Metal foil is then placed on the pre-mixed ethylene acetate/acrylate compound material. The surface of the mould which is in contact with the metal foil is not required to be nickel-lined, as there is no risk of metal foil sticking to the steel plate.

Once the materials are loaded into the ethylene acetate/acrylate element mould, the mould is placed within a press. A similar procedure is followed as with that described for the fabrication of the heating element. An initial force is applied, the press heated to a target temperature, and the force and temperature maintained for a period of time. The combination of force, temperature and time are selected to ensure that the ethylene acetate/acrylate compound is fully melted. This selection is made having regard to the particular properties of the materials used, such as the melting and degradation temperatures, as described above with reference to the HDPE heating element.

In particular, the target temperature is sufficiently high to cause the ethylene acetate/acrylate compound to melt. Ethylene acetate/acrylate copolymer based materials have melting points of around 100° C. However, it will be appreciated that the melting point varies between different ethylene acetate/acrylate copolymers (e.g. between ethylene ethyl-acrylate, ethylene methyl-acrylate and ethylene vinyl-acetate), and between blended and pure materials (e.g. between ethylene ethyl-acrylate and ethylene ethyl-acrylate blended with carbon black). The application of force is intended to ensure even heating of the ethylene acetate/acrylate compound by the top and bottom metal plates of the press. It is possible to omit the application of force at this stage, although this may require that the press is heated for a longer period of time, to ensure that the ethylene acetate/acrylate compound is fully melted. The period for which the temperature is maintained (and for which the force is optionally applied) is selected to ensure that the ethylene acetate/acrylate compound is entirely melted.

Once the ethylene acetate/acrylate compound is entirely melted, the force applied by the press is increased to a force sufficiently high to expel air from the molten material. The pressure is applied for a duration sufficiently long to expel substantially all of the air from the molten ethylene acetate/acrylate compound. The further application of pressure also allows a bond to form between the metal foil and the ethylene acetate/acrylate compound. A force of 200 kN is suitable when applied to the ethylene acetate/acrylate element mould with dimensions of 100 mm×200 mm. A period of 5 minutes is sufficient to cause substantially all of the air within the ethylene acetate/acrylate compound to be expelled, when combined with a force of 200 kN.

The formation of the bond between the metal foil and the ethylene acetate/acrylate compound may be understood by reference to the surface properties of the ethylene acetate/acrylate compound. The application of heat and pressure create conditions in which the surface tension of the ethylene acetate/acrylate compound is sufficiently low, and the ethylene acetate/acrylate compound sufficiently soft, that the ethylene acetate/acrylate compound wets the metal surface. However, when the heat and pressure are removed, the ethylene acetate/acrylate compound is sufficiently hard that it is able to resist forces applied to the bond which act to separate the materials. The strength of the bond is also understood to be enhanced by hydrogen-bonding and van der Waals interactions.

The press is then rapidly cooled to a temperature below the melting point of the ethylene acetate/acrylate compound. Cooling may be brought about by any convenient mechanism. The temperature is brought below the melting point of the ethylene acetate/acrylate compound. The temperature is also brought below any temperature at which any significant deformation or crystallisation can occur, such that the properties of the ethylene acetate/acrylate compound become stable. Cooling from around 150° C. to around 35° C. may be brought about in a time of 10 to 15 minutes. However, if a different cooling rate is required, it may be possible to cause the press to cool more quickly or more slowly.

In a similar way to that described with reference to the HDPE materials used for a heating element 34, the rate of cooling of ethylene acetate/acrylate compounds has a significant effect on the properties of the resulting part. For example, the degree of crystallinity in the resulting ethylene acetate/acrylate compound is controlled to a large extent by the cooling speed. A rapid cooling rate causes a low degree of crystallinity, whereas a slow cooling rate causes a highly crystalline material to form. The degree of crystallinity in turn has a significant effect on the self-regulating properties of the ethylene acetate/acrylate compound. A high degree of crystallinity within the ethylene-acrylate compound results in a more fixed structure, and a low coefficient of thermal expansion within the material. Conversely, a low degree of crystallinity (i.e. more amorphous structure) within the ethylene acetate/acrylate compound results in a less fixed structure and a higher coefficient of thermal expansion.

The change in thermal expansion can be related to self-regulating behaviour, as described above with reference to heating element parts comprising HDPE.

Once the ethylene acetate/acrylate compound has been cooled, the pressing force is removed, and the mould is removed from the press. The pressed parts are then removed from the moulds, with care being taken to peel the parts from the nickel plate. The parts are then cut to a required size. These parts will form the conductors 31, 32 and the ethylene acetate/acrylate elements 33, 35, and will be referred to as ethylene acetate/acrylate parts. The ethylene acetate/acrylate compound is now bonded to the metal foil.

Assembly of the electrical heater 30 is then performed. A first ethylene acetate/acrylate part is placed in a further mould, the metal foil facing the plate of the mould. A heating element (HDPE compound) part is then placed on the exposed ethylene acetate/acrylate compound surface. Finally a second ethylene acetate/acrylate part is placed on the heating element part, the ethylene acetate/acrylate compound surface making contact with the surface of the heating element, and the metal foil surface being exposed to the inner surface of the mould. The electrical heater mould has a void with similar major dimensions to the heating element and ethylene acetate/acrylate element moulds.

The heating element mould is then placed within the press. A force is applied and the press is heated to a target temperature which is above the melting point of the ethylene acetate/acrylate and heating element parts. Once the target temperature has been reached, the force is maintained for a period sufficiently long to melt the polymer compounds. The pressure applied serves to ensure even melting occurs throughout the layers of the structure, allowing heat to be supplied efficiently from both the lower and upper plates of the press. The heating duration may be increased to compensate for any uneven heating if a lower pressure is selected. Once the period of time required for melting has elapsed the force applied by the press is increased to a higher force where it is maintained for a second period. This further application of force drives air out of the work-piece, and in particular drives air from between the heating element part and ethylene acetate/acrylate part. The period of time is sufficient to ensure substantially all of the air is driven out from between the heating element part and ethylene acetate/acrylate parts and to ensure that a bond is formed between the adjacent layers. The melted surfaces of the heating element part and ethylene acetate/acrylate part are forced together so as to form a bond. A force of 200 kN is suitable when applied to a heating element mould with dimensions of 100 mm×200 mm. A period of 5 minutes is sufficient to cause substantially all of the air from between the heating element part and ethylene acetate/acrylate parts is expelled, and to form a bond between the adjacent layers, when combined with a force of 200 kN. The press is then rapidly cooled. Once cooled, the pressing force is removed, and the mould is removed from the press. The pressed parts are then removed from the moulds, the parts being peeled from the mould plates. The heating element part and ethylene acetate/acrylate parts are now bonded together.

The resulting electrical heater may have low temperature self-regulating characteristics by virtue of the positive temperature coefficient of resistance (PTC) characteristic of the ethylene acetate/acrylate compound.

The fabrication method described above can be readily altered to allow multiple devices to be fabricated at once in parallel using a press in conjunction with a plurality of moulds. For example a press may be arranged to accommodate four such moulds during each pressing operation.

The moulds used for each of the stages of the fabrication process described above may be sized according to the requirements of the electrical heater being made, and the specific requirements of any intended application. For example, a press having a mould of 100 mm×200 mm is suitable for an electrical heater. The thickness of the mould voids also has an impact on the final dimensions of the electrical heater, and also in determining the power output per unit area of a particular electrical heater as discussed in more detail below.

The self-regulating characteristics of the ethylene acetate/acrylate elements within an electrical heater can be altered by irradiation with an electron beam. An electron beam suitable for irradiating the materials used within electrical heaters according to various aspects of the present invention may be generated by an electron beam accelerator. For example, a Dynamitron electron beam accelerator, having a maximum accelerating voltage of 2.5 MeV and a maximum beam current of 70 mA (at 1.5 MeV) made by Radiation Dynamics Incorporated may be used to generate a suitable electron beam. The electron beam consists of electrons which have been accelerated within the electron beam accelerator, before being directed towards a material being irradiated.

The process of irradiating a material is accomplished by passing the material which is to be irradiated in front of an electron beam. If the material to be irradiated is in the form of discrete articles, they can be passed in front of the beam on a conveyor system, or some other form of suitable mechanical arrangement which can allow the duration for which the articles are exposed to the beam to be controlled. Multiple passes of the conveyor (or other mechanical arrangement) in front of the beam at a controlled speed can be used to ensure a predetermined electron irradiation dosage is delivered to the articles.

Alternatively, if the material to be irradiated is in a continuous form, such as a cable, the cable can be un-wound from a storage reel and wound one or more times around a capstan, which is rotated in front of the beam. By winding the cable around the capstan multiple times, each region of the cable can be passed in front of the beam a number of times, before being re-wound onto a storage reel for storage.

Any suitable mechanical arrangement could instead be used to present regions of the continuous material to be irradiated to the beam, rather than a capstan system as described above.

The dosage of electron beam irradiation being delivered to the materials can be monitored by use of indicator films, which exhibit a well defined change in colour, or some other observable property, when a predetermined radiation dose has been delivered. Alternatively, or additionally, radiation dosage levels may be measured during exposure by a suitable electron beam radiation sensor.

In a further alternative arrangement, radiation levels can be calibrated periodically, allowing a known beam current to be calibrated and determined to deliver a measured beam dosage. In this arrangement, subsequent beam current monitoring can allow sufficiently accurate indirect dosage monitoring to effectively enable continuous monitoring of the beam dosage reaching a material being irradiated, without the need for direct radiation dosage monitoring.

Constant monitoring of the beam dosage (whether direct or indirect) reaching a material being irradiated allows a control system to speed up or slow down the passage of the material past the beam, to ensure a desired dosage is received by all parts of the material being irradiated. The beam dosage reaching each part of a material being irradiated can be simply calculated if the beam intensity is known, by considering the duration that each region of the material is exposed to the beam.

The radiation dosage delivered to a material can be measured in terms of kilograys (kGy), where one kGy is the absorption of one kilojoule of energy, in the form of ionising radiation, per kilogram of material.

The depth of beam penetration into a material is, at least in part, determined by the acceleration voltage which is used to generate the electron beam. Additionally, the depth of beam penetration will vary between materials. Therefore, the acceleration voltage may be varied, for example between 0.8 MeV and 2.5 MeV, to achieve a particular beam penetration depth. It will be appreciated that for thicker materials, it will be desirable to have a deeper beam penetration than for thinner materials. An acceleration voltage of 2.5 MeV may result in a penetration depth of 7-10 mm, depending on the material being irradiated. Through routine experimentation the skilled person will be able to determine a suitable beam acceleration to achieve a desired penetration depth for a particular material.

During beam exposure, the electron beam is routinely scanned across the surface of a material at a speed which is considerably faster than the movement of the material past the beam. The electron beam is scanned across the surface of the material transverse to the direction that the material is moved past the beam. The beam scanning may be at a frequency of around 100 Hz. The beam scanning ensures that the beam is evenly distributed across the surface of the material in question, preventing any part of the material from receiving more radiation than any other part.

The electrons incident upon the material being irradiated are absorbed within the material, with the energy they carry being absorbed within that material. The absorbed energy causes carbon-carbon bonds along the polymer chains to be broken. Carbon-carbon bonds are then reformed, with some being formed between adjacent polymer molecules, while others reform in the place of those broken (i.e. along the original polymer chains). This process is known as ‘cross-linking’, and causes the material to become more fixed in its structure, with the molecules less able to move past one another without a significant additional amount of energy being required to do so.

In this way, the cross-linking process causes a material which is originally a thermoplastic material to become a thermoset material. Amongst other things, this leads to the materials melting at a higher temperature. Additionally, and for the same reasons, the electrical characteristics of a compound material are caused to be altered. In particular electrical characteristics such as PTC are altered by electron beam irradiation. The PTC characteristic involves the expansion of a matrix of an insulative material in the compound material, causing conductive particles within the resistive matrix to move further apart. Electron beam irradiation reduces the thermal expansion of the resistive matrix material, thereby reducing the effect of temperature on the electrical resistance of the compound material.

While it has been described that an electrical heater should be assembled before being irradiated it will be appreciated that it is possible to instead irradiate component parts of an electrical heater prior to assembly. For example, the ethylene acetate/acrylate elements may be irradiated before being assembled with the heating element to form an electrical heater. Each component part may be irradiated with a different dosage before assembly.

Where irradiation is carried out on samples which include a conductor, the conductor should be connected to earth to allow the electron current to be safely carried away. Irradiation is not expected to have any significant transformative effect on the conductor other than heating. Where a conductor, such as a foil conductor, is included at the surface of an electrical heater which is to be irradiated, it is expected that the presence of the foil conductor will have a negligible effect on the beam penetration depth in the material.

The irradiation process may have a particularly beneficial effect on ethylene acetate/acrylate compounds. In particular, ethylene acetate/acrylate compounds tend to be unstable when used within an electrical heater. It is expected that continuous use carrying current and heating/cooling can lead to material changes within the ethylene acetate/acrylate compound, and a drift in the self-regulating characteristics of the ethylene acetate/acrylate compound over time. For example, within the ethylene acetate/acrylate compound, the relative ease with which polymer chains can move past one another, and ease with which conductive fillers can move can result in a significant change in the distribution of conductive filler within the ethylene acetate/acrylate compound. This results in a significant change in the PTC or self-regulating characteristics. For example, the conductive filler may over time move to form conductive pathways which offer less resistance, thereby causing the power consumption of the electrical heater to increase. Electron beam irradiation can prevent this by cross-linking the polymer chains, and fixing the properties of the material

On the other hand, electron beam irradiation may not have a significant effect on materials such as HDPE which may also be used in electrical heaters. HDPE typically has a higher degree of crystallinity than ethylene acetate/acrylate compounds, which are more amorphous (i.e. less cross-linking). The properties of HDPE are therefore less susceptible to change with time, and consequently benefit less from electron beam irradiation.

As described above, electron beam irradiation effectively fixes the structure of the ethylene acetate/acrylate compound by promoting cross-linking between polymer chains. In this way, irradiation reduces degree of movement which can occur within an ethylene acetate/acrylate compound, and therefore not only reduces the degree of self-regulating behaviour (as described above) but also reduces the extent to which the self-regulating characteristics drift when repeatedly used. While the radiation dosage required to bring about a desired fixing effect through cross-linking will vary from one material to another, it is possible to determine the degree to which cross linking has occurred by performing tests on the cross linked material. The gel content of a polymer material is a measure of the proportion of the material which is cross-linked, forming an insoluble portion. The gel content of the polymer material can be measured. To measure the gel content, a measured mass of the cross-linked polymer sample is boiled in a suitable solvent. Any polymer material within the sample which is not cross-linked will be dissolved in the solvent. On the other hand, any cross-linked material within the sample will not be dissolved. The residual solvent is then removed and the sample dried, before the sample is again weighed. The proportion of polymer remaining is the gel fraction, the amount of which is the gel content of the material.

A standard test for determining the gel content in cross-linked ethylene-based polymer materials is provided by the American Society for Testing and Materials (ASTM) as test number D2765-1. The general test principal can be applied to other polymer materials. Typical solvents used are toluene, xylene and decahydronaphthylene. Other solvents may be required for other polymers. Appropriate solvents can be chosen by selecting a solvent for which the un-cross-linked polymer of interest has a high degree of solubility, but which does not dissolve the cross-linked polymer.

To accurately determine the gel content of an ethylene acetate/acrylate copolymer compound it may be necessary to take further steps in addition to those described above. For example, depending on the size of any conducting particles distributed within the ethylene acetate/acrylate copolymer matrix they may be removed as the un-cross-linked polymer is dissolved (i.e. small particles may be removed from a cross-linked region, while larger particles may remain within the cross-linked region).

One further method which may be used in combination with the method described above is thermal gravimetric analysis (TGA). The residual sample of cross-linked material may be heated in a nitrogen atmosphere to volatilise the polymer material, following which oxygen is introduced to oxidise any carbon. TGA allows a determination to be made of the mass lost at each stage (i.e. volatilisation and oxidation), allowing an accurate measure of the mass of each component. This provides a measure of the conductive particle fraction within the residual cross-linked sample, allowing this to be excluded from any calculation of gel content.

Typically, a material could be considered to be cross-linked if it has a gel content greater than around 60% by weight. Thus, the ethylene acetate/acrylate copolymer may be provided with a gel content greater than around 60% by weight. Measurement of the gel content of a polymer may have an accuracy of around +/−1%. The extent of cross-linking of a polymer increases gradually as the gel content is increased (there is not a rapid transition from not being cross-linked to being cross-linked). Taking into account the limited accuracy of the gel content measurement and the gradual increase of cross-linking with gel content, it may be preferable to provide the ethylene acetate/acrylate copolymer with a gel content of 65% or more by weight. A gel content of around 80% (e.g. between 75% and 85%) by weight may provide a stable cross-linked material which is resistant to significant alterations in characteristics under prolonged use.

A gel content of up to around 90% by weight may be used for the ethylene acetate/acrylate copolymer. A gel content of greater than 90% by weight may result in the ethylene acetate/acrylate copolymer becoming too damaged by radiation to function as a PTC material. For example, greater than 90% cross-linking may lead to brittleness and stress-cracking of the ethylene acetate/acrylate copolymer.

In one example, an ethylene methyl-acrylate based self-regulating material which, prior to electron beam irradiation, may self-regulate at 40° C., may self-regulate at 50° C. or 60° C. after electron beam irradiation. FIG. 5 illustrates the temperature-power characteristics of electrical heaters having the configuration shown in FIG. 2. The ethylene acetate/acrylate element 21 of each of the electrical heaters tested is formed from ethylene methyl-acrylate and carbon black. The ratio by weight of these materials in the electrical heaters is 65% ethylene methyl-acrylate and 35% carbon black. The electrical heaters were made using the process described further above. The electrical heaters were then irradiated with various dosage levels of electron beam radiation. For each of the electrical heaters, the normalised power output is shown as a function of temperature between 0° C. and 60° C. The normalised power is calculated as the ratio of the power output at each temperature to the power output at 0° C. when a fixed voltage is applied between the first and second conductors 22, 23.

Considering the temperature-power characteristic for the un-irradiated sample (represented by triangles), it can be seen that the power of the electrical heater 20 decreases as a function of temperature. It will be appreciated that this PTC characteristic allows the electrical heater to be self-regulating. If the temperature of the electrical heater were to increase, the resistance of the electrical heater would also increase. If the resistance of the electrical heater were to increase, the amount of current flowing though the device would decrease (provided a constant voltage is applied to the electrical heater). Consequently, if the temperature is increased, the current is reduced and the power output of the electrical heater is also reduced, reducing the temperature of the electrical heater. In this way, the electrical heater is able to maintain a constant temperature, or self-regulate. While the PTC characteristic shown is that of a gradual curve, it will be appreciated that for a given fixed voltage which is applied to the electrical heater, and a given set of external conditions (such as the ambient temperature, and the heat capacity of the environment in which the electrical heater is installed) an electrical heater will self-regulate at a particular temperature. For the purposes of illustration only, it will be assumed that the self-regulation temperature of a given electrical heater is the temperature at which the power output becomes 10% of the power output of that electrical heater at 0° C.

The characteristic fall in power output (caused by a rise in resistance) with increasing temperature is also seen for each of the irradiated electrical heaters, as shown in FIG. 5. However, it can also be seen that by using a higher radiation dosage, the rise in resistance with temperature is reduced. For example, the electrical heater which has been irradiated with a dosage of 50 kGy (represented by squares) exhibits a smaller power decrease than the un-irradiated sample (represented by triangles). Further, the electrical heater which has been irradiated with a dosage of 75 kGy (represented by diamonds) exhibits a smaller power decrease than the electrical heater which has been irradiated with a dosage of 50 kGy (represented by squares). Further still, the electrical heater which has been irradiated with a dosage of 100 kGy (represented by crosses) exhibits a smaller power decrease than any of the other electrical heaters. The electrical heater which has been irradiated with a dosage of 100 kGy (represented by crosses) may have a gel content of around 80%.

Considering the un-irradiated electrical heater, according to the assumption that self-regulation occurs at the temperature at which the power output is 10% of the power output at 0° C., the self-regulation temperature can be seen to be around 54° C. However, comparing the characteristic of the un-irradiated electrical heater to that of the electrical heater which has received 100 kGy or radiation, it can be seen that the irradiated electrical heater has a self-regulating temperature of around 60° C. Therefore, the process of irradiation can be seen to increase the self-regulation temperature. As explained above, the cross-linking brought about by irradiation restricts movement between the polymer chains, and therefore reduces the thermal expansion of the polymer material, thereby reducing the effect of heating on the resistance, and consequently power output.

It can also be seen that radiation dosage has an effect on the change in self-regulation temperature. Lower radiation doses bring about smaller changes in self-regulating temperature shift than higher radiation doses. By adjusting the radiation doses it is therefore possible to select a particular self-regulation temperature.

A further effect of the irradiation, also discussed above, is the improvement in material stability. A higher radiation dose will result in a more significant improvement in the stability of a self-regulating material, and consequently an improved lifetime within an operational electrical heater. For example, an un-irradiated electrical heater having an ethylene acetate/acrylate element formed from an ethylene acetate/acrylate compound can be expected to significantly alter its characteristics after only a few switching cycles. Such an electrical heater would be expected to become more conductive (i.e. have a lower resistance) after any significant duration of operation. This is because the conductive particles within the ethylene acetate/acrylate compound are relatively free to migrate, especially when the material is at an elevated temperature. Due to this migration, an un-irradiated electrical heater may become hotter and hotter, and more and more conductive in use, with the self-regulation temperature increasing until the electrical heater is at or above the melting point of the component materials. For this reason, an electrical heater having a heating element which comprises un-irradiated ethylene acetate/acrylate, and which does not comprise a separate heating element (such as a HDPE compound heating element) may only be suitable for use in disposable applications.

An electrical heater which has been irradiated (with, for example, 100 kGy of radiation) might be expected to operate continuously for several years without showing significant deterioration (increase) in self-regulation temperature or reduction in resistance. A higher dosage of radiation will cause the characteristics of the ethylene acetate/acrylate compound to be more strongly locked-in. However, it should also be appreciated that too high a dose of radiation can damage the ethylene acetate/acrylate compounds. A radiation dosage which causes greater than 90% cross-linking may be considered to be damaging to the ethylene acetate/acrylate compounds.

While the use of ethylene acetate/acrylate elements as temperature regulation elements is discussed above, in some embodiments it may be preferable for an ethylene acetate/acrylate element to be highly conductive. A highly conductive ethylene acetate/acrylate element may provide a low resistance contact between a heating element comprising an HDPE compound, and a metal conductor. To achieve a highly conductive ethylene acetate/acrylate element the ethylene acetate/acrylate compound does not require irradiation. During use, the ethylene acetate/acrylate compound which has not been fixed by irradiation may become mobile, and conductive pathways created within the material.

In embodiments in which a highly conductive ethylene acetate/acrylate element is used, the ethylene acetate/acrylate element would not function as a heating element or a temperature regulation element, but may instead function only as an adhesion element.

For example, the electrical heater 30 illustrated in FIG. 3 may include non-irradiated first and second ethylene acetate/acrylate elements 33, 35 which function as adhesion elements and which do not function as temperature regulation elements or heating elements.

In addition to using irradiation to cause ethylene acetate/acrylate elements to be either conductive or self-regulating, it is possible to use irradiation to select the extent to which ethylene acetate/acrylate elements self-regulate (as explained above). Moreover, depending on the choice of PTC material in both the heating element and the ethylene acetate/acrylate elements, and the use of irradiation, an electrical heater can be designed to self-regulate at a specific pre-determined temperature.

The use of ethylene acetate/acrylate compounds within an ethylene acetate/acrylate element which functions as a temperature regulation element allows a self-regulating temperature of around 60° C. to be achieved. A self-regulation temperature of 60° C. may result in the temperature within a device which is heated by the electrical heater being maintained at a temperature of around 50° C., considering the thermal capacity of the device which is heated, and any losses associated with the device. Conventional heating cables having a heating element which comprises an HDPE compound heating element which also functions as a temperature regulation element typically self-regulate at around 75° C. or above. Therefore, if the intended purpose of the electrical heater is as a freeze prevention device, any energy used heating the electrical heater significantly higher than 0° C. is wasted energy. Therefore, reducing the self-regulation temperature closer to the temperature at which the device which is heated is intended to operate provides a significant advantage by reducing the amount of energy wasted in heating the electrical heater to a temperature above that which is required.

In an alternative embodiment, two ethylene acetate/acrylate elements within a single electrical heater may have different self-regulating (PTC) characteristics. A first ethylene acetate/acrylate element may be formed from a first ethylene acetate/acrylate compound, and a second ethylene acetate/acrylate element may be formed from a second ethylene acetate/acrylate compound. Alternatively, the same ethylene acetate/acrylate compound may be caused to have a different self-regulating (PTC) characteristic by virtue of the electron beam irradiation treatment, or cooling duration during pressing. In this way, an electrical heater may have a more complex temperature-resistance characteristic than that seen in FIG. 5. For example an electrical heater may have a first temperature-resistance gradient at a first temperature and a second temperature-resistance gradient at a second temperature.

In an embodiment a first ethylene acetate/acrylate element may function as a temperature regulation element and as an adhesion element while a second ethylene acetate/acrylate element may function as an adhesion element and not as a temperature regulation element.

Additionally, an electrical heater may further comprise one or more components which have a negative temperature coefficient of resistance. For instance, in addition to an ethylene acetate/acrylate layer having a PTC characteristic, a NTC layer may be included to act as a cold-start limiter. A cold-start limiter works by having a large resistance when an electrical heater is switched on at a cold temperature, preventing a large current surge from being drawn from the power supply. The NTC characteristic will then result in a reduction in resistance as the electrical heater heats up. When the electrical heater reaches a normal operating temperature the PTC characteristic begins to dominate, and the electrical heater will self-regulate as discussed above. PTC and NTC components may be included in series combination. Alternatively, one ethylene acetate/acrylate element may have a PTC characteristic, while a second ethylene acetate/acrylate element may have a NTC characteristic. For example, in the electrical heater 30 described with reference to FIG. 3, the first ethylene acetate/acrylate element 33 may have a PTC characteristic while the second ethylene acetate/acrylate element 35 may have a NTC characteristic. In a further alternative, a blended material may have both PTC and NTC characteristics.

The term temperature regulation element may be used to refer to an element having a PTC characteristic, an NTC characteristic or both PTC and NTC characteristics.

In the above embodiments, the use of a press has been described as the mechanism by which the electrical heater is fabricated. However, it will equally be appreciated that other manufacturing methods may be used. Any technique which allows the controlled application and distribution of pressure and heat to a device may be used to manufacture an electrical heater in accordance with embodiments of the invention. For instance, other processes could be used to apply pressure and heat to obtain the desired bonding between the various components of the electrical heater, and to shape the material into the desired form.

Hot rolling is a known manufacturing technique. In hot rolling, the rollers used to process (shape) the material are used to further heat the compound being rolled. Hot rolling could be used to form an electrical heater according to embodiments of the invention. Hot rolling is a continuous process, and is thus able to produce electrical heaters having a length far in excess of those possible by pressing methods.

Alternatively, an extrusion process may be used to fabricate an electrical heater using materials described above with reference to a pressing process. For example, an HDPE compound or ethylene acetate/acrylate compound may be loaded into the hopper of an extruder, and then heated and compressed in a continuous manner, before being extruded through a die at a predetermined temperature and pressure. The continuous nature of the extrusion process means that idle periods are required between processing steps, and that a separate melting phase does not need to be carried out in advance of a compression/bonding phase.

Material entering the extrusion process will gradually be compressed by a screw and heated as it approaches the die. A typical extruder screw may use a compression ratio of 3:1 along its length, compressing and heating pelletized HDPE or ethylene acetate/acrylate compound materials. As the material reaches the die it will be molten, and have had all air expelled by the application of force.

The pressure at the die of an extruder may for example be 100 bar. A force of 200 kN applied to a pressed part with dimensions of 200 mm×100 mm, as described above is equivalent to a pressure of 100 bar, which may be observed at the die of an extruder. A pressure of as much as 650 bar may be observed at the die of an extruder. Such high pressures may be beneficial during fabrication of some parts.

In an example extrusion process, an extruded ethylene acetate/acrylate element may be extruded at a rate of 4-5 metres per minute. Once extruded, the ethylene acetate/acrylate element may be cooled by being passed through a cold roller.

It will be understood that extrusion may be an appropriate method for the fabrication of ethylene acetate/acrylate elements for use in electrical heaters. In order to select appropriate extrusion conditions the viscosity and melt flow index of an ethylene acetate/acrylate material may be taken into account. Selection of an appropriate set of extrusion conditions for a particular polymer (including ethylene acetate/acrylate copolymer) material will be well known to one of ordinary skill in the art.

By using an extruder, a strip of heating element or ethylene acetate/acrylate element material could be formed having any desired profile, in a continuous process, yielding lengths far in excess of those possible by pressing methods. Having fabricated strips of heating element or ethylene acetate/acrylate element materials by extrusion, an electrical heater can be assembled by passing a number of strips through a hot roller to bond each layer to each other layer.

For example, an extruded ethylene acetate/acrylate element may be assembled into an electrical heater by being passed, while still hot, through rollers. One or more conductors (e.g. metal foil, such as aluminium foil) are provided adjacent to the extruded ethylene acetate/acrylate element and combined with the extruded ethylene acetate/acrylate element by the rollers. The separation of the rollers determines the thickness of a finished electrical heater. The rollers apply pressure to the outer surface of the conductors, causing the inner surface of the conductors to come into close contact with the extruded ethylene acetate/acrylate element, and a strong bond to form between the inner surface of the conductors and the extruded ethylene acetate/acrylate element.

The rollers may be heated (i.e. hot rollers) to supply additional heat to the extruded ethylene acetate/acrylate element. This may assist with the formation of a strong bond. Alternatively, the rollers may not be heated, and the bond formed by relying on the extruded ethylene acetate/acrylate element being molten as a result of the extrusion process (i.e. the extruded ethylene acetate/acrylate element having remained hot between being extruded and combined with the conductors). To ensure that the extruded ethylene acetate/acrylate element does not cool significantly between being extruded and combined with the conductors (whether the rollers are heated or not), the separation between the exit of the extrusion die and the rollers may be small. The separation may be, for example, around a few millimetres. The separation between the exit of the extrusion die and the rollers may be, for example, less than a few centimetres (e.g. less than 10 cm).

The manufacture of an electrical heater using a process in which the ethylene acetate/acrylate compound is heated only once, and does not cool significantly (and thus solidify) before being bonded, may allow a stronger bond to form than a process in which an ethylene acetate/acrylate compound is heated, extruded and cooled prior to being re-heated for assembly. Such a process (i.e. a process in which the ethylene acetate/acrylate compound is heated only once, and does not cool significantly before being bonded) may be referred to as involving a single heating cycle. An electrical heater having been formed and assembled as described above (i.e. in a single heating cycle) may then be cooled, for example, by being passed through a cold roller (as described above), or through a water bath.

It will be appreciated that the application of a large force, for example a force of 200 kN, as described above, is an example of a force that may be used to apply a pressure to an electrical heater, in combination with a high temperature, in order to cause a strong bond to be formed between the ethylene acetate/acrylate compound and the metal foil in a particular manufacturing process. Such an application of pressure, while the metal foil is in contact with the ethylene acetate/acrylate compound, both expels air from within the ethylene acetate/acrylate compound and from between the ethylene acetate/acrylate compound and the metal foil. The pressure also forces the ethylene acetate/acrylate compound to flow into any surface features of the metal foil. However, a smaller or greater pressure may be used.

The maximum pressure which may be used depends on material properties and the mechanical arrangement of the apparatus used to apply the heat and pressure. The maximum pressure may, for example, be the maximum pressure which can be applied which does not cause the molten ethylene acetate/acrylate compound to be entirely forced from between the metal foils. Such a maximum pressure thus depends on several parameters such as the viscosity of the ethylene acetate/acrylate compound and the geometry of the apparatus. The use of too high a pressure may cause molten ethylene acetate/acrylate material to be squeezed entirely from between the metal foils such that they come into contact with one another, causing a short circuit.

The minimum pressure which may be used also depends on processing considerations, such as, for example, production speed. For example, the application of a higher pressure may increase the rate at which air is expelled from between the ethylene acetate/acrylate compound and the metal foils, and may also increase the rate at which a bond is formed between the ethylene acetate/acrylate compound and the metal foils. The use of a low pressure (e.g. around 1 bar), may allow an adequate bond to form, but may be considered to be uneconomic (i.e. the process will work technically, but could be too slow to be commercially viable). Therefore, 1 bar could be a minimum pressure applied during the formation of a bond between an ethylene acetate/acrylate compound and a metal foil.

The pressure used may be a pressure which allows a bond to be formed in a convenient time period. In some embodiments, a small pressure (e.g. 5 bar) may be sufficient to cause a bond to be formed between the ethylene acetate/acrylate element and the metal foils in a convenient time period. In other embodiments higher pressures (e.g. 100 bar or more, as described above) may be used.

It will be appreciated that electrical heaters which further comprise heating elements and optional additional ethylene acetate/acrylate elements may also be manufactured by the use of extrusion and rolling as described above. For example, extruded first and second ethylene acetate/acrylate elements and a single heating element can be combined with each other and with first and second conductors by rolling.

Moreover, electrical heaters which further comprise heating elements and optional additional ethylene acetate/acrylate elements may be manufactured in several steps. For example, in a first step a first ethylene acetate/acrylate element is formed. In a second step, a heating element is formed. In a third step a second ethylene acetate/acrylate element is formed. In a fourth step the first ethylene acetate/acrylate element is bonded to a first conductor, the heating element is bonded to the first ethylene acetate/acrylate element, the second ethylene acetate/acrylate element is bonded to the heating element and the second conductor is bonded to the second ethylene acetate/acrylate element. It will be appreciated that various combinations of the steps described above can be carried out concurrently, or immediately following one another, allowing an electrical heater to be formed by a single apparatus and/or in a single process. In the several step process described above, the formation of the elements may be carried out by extrusion and the bonding between the respective elements and conductors may be carried out by rolling. It will be appreciated that other techniques may be used for these steps.

Where an ethylene acetate/acrylate element operates as an adhesion element, it may be particularly beneficial for the ethylene acetate/acrylate element to be exposed to only a single heating cycle during manufacture, as described above. Second (and subsequent) heating cycles may result in a reduction in the strength of the bond formed between the ethylene acetate/acrylate element and a conductor.

FIG. 6 shows an electrical heater 50 which may be fabricated by a continuous method for example such as extrusion and/or rolling as described above. The electrical heater 50 comprises a stack of a first conductor 51, a first ethylene acetate/acrylate element 52, a heating element 53, a second ethylene acetate/acrylate element 54 and a second conductor 55. The first and second conductors 51, 55 may be formed from a layer of metal foil. The metal foil may be any suitable metal, such as, for example aluminium foil. The parts of the electrical heater 50 may be assembled and together passed through a hot roller to form the electrical heater 50. The application of force and heat by the roller will force out any air, cause the layers to partially melt, and bond the layers tightly together.

The electrical heater 50 is elongate, having the shape of a ribbon, extending in a first dimension x significantly less than in a second dimension y. The thickness, in the z dimension, is less than either of the first and second dimensions. The electrical heater 50, having a thickness which is significantly less than the width or length allows the heater 50 to be flexible. The use of thin layers results in a ribbon which can be wound around an article to be heated, such as, for example a fluid carrying conduit.

The electrical heater 50 could alternatively be formed in a single process using an extrusion machine. Separate dies could be used to sequentially extrude each component part, before rolling them together, while still hot, to form the finished product. Alternatively, multiple extruded layers could be coextruded through a single die, before having conductors applied to the combined heating element and ethylene acetate/acrylate elements, and the final part rolled to ensure good adhesion between the various parts.

In an alternative embodiment an electrical heater in the shape of a ribbon may comprise an ethylene acetate/acrylate element sandwiched between two conductors.

In alternative embodiments, an extrusion process could be used to form electrical heaters having a variety of different shapes (provided that those shapes are continuous in form such that they can be extruded).

FIG. 7 shows a further embodiment of an electrical heater 60 in which the electrical heater 60 is arranged in a circular form, allowing the electrical heater to extend along and around a tube 61. In such an embodiment the electrical heater 60 may be used to heat the contents of the tube 61, so as to prevent it from freezing. The electrical heater 60 comprises a first conductor 62 which extends around the tube 61, an ethylene acetate/acrylate element 63 which extends around the first conductor 62, and a second conductor 64 which extends around the ethylene acetate/acrylate element 63. The stack of elements comprising the electrical heater 60 forms a continuous sheath around the tube 61.

The electrical heater may, in an alternative embodiment, further comprise a separate heating element and may further still comprise a second ethylene acetate/acrylate element, as described with reference to electrical heater 30 and FIG. 3.

The electrical heater 60 may be formed by an extrusion process. In such a process, the first conductor 62 is extruded from a metal, e.g. aluminium, around the tube 61. The ethylene acetate/acrylate layer 63 is then extruded around the first conductor 62. Finally, the second conductor 64 is extruded from a metal, e.g. aluminium, around the ethylene acetate/acrylate element 63. Alternatively several of the layers 62, 63, 64 may be extruded around the tube 61 sequentially in a single pass through an extrusion machine. Several of the layers 62, 63, 64 may also be co-extruded around the tube 61 in a single pass through an extrusion machine.

In a further alternative, the stack of heating elements may be formed as a flat stack, for example as shown in FIG. 2, 3, 4 or 6, but may be wrapped around a tube so as to extend around and heat the tube.

The adhesion properties of the ethylene acetate/acrylate compounds are affected by the material used, and also by the conductive filler which is mixed with the ethylene acetate/acrylate copolymer material. The use of a greater proportion of a conductive filler material will increase the conductivity of the compound material. Any increase in conductivity of the material allows an electrical heater using the device to operate at a lower voltage. The use of a lower operating voltage may be an advantage in some applications, in particular where high voltage power supply equipment would otherwise be needed.

However, it should also be noted that a greater proportion of conductive filler material will also reduce the adhesive effect of the ethylene acetate/acrylate copolymer material within the ethylene acetate/acrylate compound. The increase in proportion of filler material will be accompanied by a corresponding decrease in the proportion of acetate/acrylate groups within the compound. It is believed that the acetate/acrylate groups are responsible for the strong adhesive strength of the material, and therefore any reduction in the number of acetate/acrylate groups will lead to an associated loss in adhesive properties.

Therefore, in selecting the proportion of conductive filler material to blend with the ethylene acetate/acrylate copolymer material, a compromise may be found between adhesive and conductive properties. Up to 45% by weight of carbon black may be blended with ethylene vinyl-acetate and still produce a compound with adequate adhesion properties for use in an electrical heater according to embodiments of the invention. For example, the use of around 35% by weight of carbon black blended with ethylene vinyl-acetate yields a conductive compound with adequate adhesion properties to bond to both aluminium and copper conductors, and as such is appropriate for use in an electrical heater according to embodiments of the invention.

Embodiments of the invention may use carbon black as the conductive filler material. Carbon black is straight forward to use because it is widely available and has known properties when used as a conductive filler material in electrical heaters. However, alternative conductive filler materials, as shown in Table 1 may be used instead of carbon black. If such alternative materials are used, then an adjustment to the proportions used may be made to achieve similarly performing electrical heaters to those achieved with carbon black. It will be appreciated that conductive filler materials with a higher aspect ratio than spherical carbon black, such as, for example carbon fibres and carbon nanotubes, will lead to significantly different conductive pathways within the compound material. A conductive pathway within the compound material is likely to consist of alternately a portion within a conductive particle, and a portion between conductive particles where the conductive pathway bridges between adjacent conductive particles. It is these gaps which limit the conductivity of the material, and also which control the self-regulating behaviour of the material. Therefore, any change to the proportion of a conductive pathway which is made up of conductive particles rather than gaps between particles will have a significant impact on the conductivity and self-regulating behaviour of the material.

In general, up to around 45% by weight of carbon black may be used in the ethylene acetate or ethylene acrylate copolymer. If more than around 45% were to be used then there may be a risk that the electrical heater includes too many conductive pathways without significant amounts of polymer, such that heater does not provide useful self-regulation. In general, around 5% or more by weight of carbon black may be used in the ethylene acetate or ethylene acrylate copolymer. If less than 5% were to be used then there may be a risk that the electrical heater does not include enough conductive pathways, such that the heater does not conduct sufficient electricity to allow it to be used as an electrical heater. Within the range 5% to 45% the amount of carbon black which is used may be selected depending upon the specific application for which the electrical heater will be used (e.g. taking into account the voltage that will be applied to the heater in use, which may vary from 12V to kVs).

If a conductive material other than carbon black is used which has a similar aspect ratio to carbon black, then the same or similar proportions of conductive filler and ethylene acetate or ethylene acrylate copolymer may be used. The conductivity of the material may be taken into account, and this may modify slightly the amount of conductive filler used. For example, if metal powder were to be used instead of carbon black, the higher conductivity of metal powder may be such less is needed than is the case for carbon black. For example, as little as 2% metal powder may be needed to make a useable electrical heater. Similarly, more than 35% of metal powder could provide conductivity which is so high that the heater does not provide useful self-regulation.

The use of high aspect ratio particles of a filler material will allow a conductive pathway within a single particle to cover a significant distance, with fewer gaps required for each conductive pathway than would be required if particles with a lower aspect ratio were used. Thus, less filler material may be used. For example, if carbon fibres were to be used instead of carbon black, then the inclusion of 5-10% by weight of the carbon fibres could provide a conductivity equivalent to the inclusion of 35% by weight of carbon black. In general, as little as 2% by weight of carbon fibre may be used. If carbon nanotubes were included, then 2-3% by weight of nanotubes might have the same effect on conductivity as 35% by weight of carbon black. In general, the proportion of conductive filler with high aspect ratio used may be selected based upon the aspect ratio of that conductive filler and the specific application for which the electrical heater may be used (e.g. taking into account the voltage that will be applied to the heater). In this document the term “high aspect ratio” may be interpreted as meaning an aspect ratio which is significantly larger than the aspect ratio of carbon black.

In general, alterations to the composition of compound materials can be made to take advantage of the different properties of alternative materials.

A combination of different conductive fillers could be used. For example, a blend of carbon black particles and carbon nanotubes could be used as a conductive filler material in an ethylene acetate/acrylate compound for use in electrical heaters. An adjustment to the proportions of each filler material may be required to take into account the difference in aspect ratio of the particular filler materials used.

Any one of the heating element or the ethylene acetate/acrylate elements may comprise a PTC element. Alternatively, any combination of the heating element or the ethylene acetate/acrylate elements may comprise PTC elements. By adjusting the material properties of component materials a temperature-resistance profile can be designed to suit a particular application. For example, the combination of several PTC elements with different PTC characteristics may allow for a more gradual reduction in the power delivered to an electrical heater as the electrical heater approaches a target self-regulating temperature.

Although embodiments of the electrical heater have been described as comprising separate ethylene acetate/acrylate elements and a heating element, the bonding process used to form the electrical heater will cause some mixing at each interface between the ethylene acetate/acrylate elements and heating element. As such, a well defined boundary between the layers may not be immediately discernible on inspection of such an electrical heater, rather a gradual transition between the heating element and each ethylene acetate/acrylate element.

Although distinct heating and ethylene acetate/acrylate elements are discussed, materials such as ethylene acetate/acrylate copolymers and HDPE may be co-polymerised so as to achieve a compound material with the beneficial properties of each component. These materials may alternatively or additionally be compounded together by mixing the materials in a pelletized form prior to filling of the press moulds or extrusion hoppers. A heating element may thus comprise a mixture of HDPE and ethylene acetate/acrylate materials, having characteristics which are a mixture of the characteristics of each individual material. For example, a blended heating element may have a self-regulating characteristic which is similar to that of a conventional HPDE compound based heating element, but may also have adhesion properties which are improved due to the use of an ethylene acetate/acrylate compound.

In addition to those materials described above, embodiments of the invention may further comprise thermal stabilisers. Depending on the method of compounding used, thermal stabilisers may be added in the range of approximately 1 to 15%. When there is a risk of damage to the ethylene acetate/acrylate compounds due to them being subjected to harsh mechanical processing conditions (e.g. shear forces, friction, temperature rises) during processing, the addition of thermal stabilisers may act to reduce or prevent any such damage.

The electrical heater 30, as illustrated in FIG. 3, and which comprises the stack of the first conductor 31, the first ethylene acetate/acrylate element 33, the heating element 34, the second ethylene acetate/acrylate element 35 and the second conductor 32 is arranged in a rectangular shape. Each of the layers of the stack has the same length in a first direction x and the same length in a second direction y. Different layers have different thicknesses. Each of the layers of the stack lies substantially parallel to each other layer, and to a plane x-y.

When in use, with a voltage applied between the conductors 31, 32 of the electrical heater 30, the heat output of the electrical heater 30 is determined by the combined thickness of the heating element 34 and the ethylene acetate/acrylate elements 33, 35 between the first and second conductors 31, 32, and by the size of the electrical heater 30. The thicknesses of the heating element 34 and the ethylene acetate/acrylate elements 33, 35 determine the heat output per unit area of the electrical heater 30. The area of the device determines the overall heat output of the device, which is the product of the area and of the heat output per unit area.

In an alternative embodiment, the length in a first dimension may be the same as the length in a second dimension, forming a square electrical heater. Alternatively an electrical heater may be circular in shape. An electrical heater may be any other shape as required for a particular application.

In a yet further alternative embodiment, an electrical heater 70 may be formed as an offset stack, as shown in FIG. 8. The electrical heater is provided with a first conductor 71 and a first ethylene acetate/acrylate element 72 which extend in the y direction to a greater extent than in the x direction. A heating element 73 extends in the x direction to a greater extent than either of the first conductor 71 or the first ethylene acetate/acrylate element 72. The electrical heater 70 is also provided with a second ethylene acetate/acrylate element 74 and a second conductor 75. The second ethylene acetate/acrylate element 74 and a second conductor 75 extend in the y direction to a greater extent than in the x direction. The first and second conductors 71, 75 are metal foils. The first ethylene acetate/acrylate element 72 and first conductor 71 are disposed at a first edge of the heating element 73, while the second ethylene acetate/acrylate element 74 and second conductor 75 are disposed at a second edge of the heating element 73. The first ethylene acetate/acrylate element 72 and a first conductor 71, and second ethylene acetate/acrylate element 74 and second conductor 75 are spaced apart from one another so as to run parallel to each other on opposite sides of the heating element 73 while not overlapping. In such an arrangement, the heat output delivered by the electrical heater 70 will be determined by both the thickness of the heating element 73, and also by the lateral separation, in the x-direction between the first and second conductors 71, 75.

In general, electrical heaters according to embodiments of the invention may have a stacked structure. This may also be regarded as a sandwich structure, the one or more ethylene acetate/acrylate elements and the optional heating element being sandwiched between the first and second conductors. In some embodiments a stack may be substantially planar, each layer of the stack lying substantially parallel to a plane having a fixed separation. Each layer of the stack may have a substantially uniform thickness. However, in some embodiments layers of the stack may have a separation which varies. For example, in some embodiments, layers of the stack may be mutually inclined.

In some embodiments layers of the stack may be curved. For example, an electrical heater may be considered to be substantially planar, each layer of the stack having a fixed separation. Each layer of the stack may have a substantially uniform thickness. However, such an electrical heater may be applied to a curved article (e.g. a pipe) such that the layers of the stack are each arranged to follow a curved surface of the article.

Such an electrical heater may still be regarded as being substantially planar, in spite of the layers not lying substantially parallel to a plane. It will be appreciated that the generally flexible nature of electrical heaters according to embodiments of the invention allows such electrical heaters to conform to a large number of shapes, as required by a desired application.

In a yet further alternative embodiment, an electrical heater 80 may take the form of a heating cable, as shown in FIG. 9. The heating cable 80 comprises a first conductor 81 and a second conductor 82. The conductors 81, 82 are wires which extend along the length of the cable 80. The conductors 81, 82 are spaced apart from one another so as to run parallel to each other. The conductors 81, 82 are embedded within a heating element 85, which may for example be formed from carbon black in HDPE (or other suitable materials as set out in table 2). The heating cable 80 further comprises a first ethylene acetate/acrylate element 83 and a second ethylene acetate/acrylate element 84. Each of the conductors 81, 82 is embedded within a respective ethylene acetate/acrylate element 83, 84. The heating element 85 is encased within an outer sheath 86, which provides mechanical protection to the heating cable 80.

In such an arrangement, the heat output delivered by the heating cable 80 will be determined by the separation between the between the first and second conductors 81, 82. The conductors 81, 82 take the form of stranded copper wires, known as buswires. The ethylene acetate/acrylate elements 83, 84 surround the conductors 81, 82 and penetrate the spaces between the buswires. The penetration of the ethylene acetate/acrylate elements 83, 84 into the buswires of the conductors 81, 82 ensures that a strong mechanical and electrical contact is formed between the ethylene acetate/acrylate elements 83, 84 and the conductors 81, 82.

The heating cable 80 is manufactured by coating the stranded copper bus wires 81, 82 with an ethylene acetate/acrylate compound, thereby forming the ethylene acetate/acrylate elements 83, 84. A HDPE based heating element 85 is then extruded over the coated bus wires to form the heating cable 80.

The conductors 81, 82 may be aluminium instead of copper. The conductors may be other suitable metals. The conductors may be solid wires, rather than stranded wires.

In an embodiment a heating cable may be formed having first and second conductors embedded within a single ethylene acetate/acrylate element. The single ethylene acetate/acrylate element would function as the heating element and the temperature regulation element.

In an embodiment, the thickness of a heating element may vary and may therefore deliver a different heat output to different locations. For example, an electrical heater in the form of a ribbon as shown in FIG. 6 may have a heating element thickness in the z-dimension which varies along the length of the ribbon. A particular region may be required to deliver a higher heat output than another region along the ribbon, and be designed to have a different thickness. For example, a thinner region of ribbon will result in a higher current flowing through that region of the ribbon and a higher heat output being generated in that region. Conversely, a thicker region will result in a lower current flowing through that region of the ribbon and a lower heat output being generated in that region. In a further example, an electrical heater in the form of a rectangular heater as shown in FIG. 2 may have a thickness in the z-dimension which undulates along the y-dimension. The thickness may describe a sinusoid. This example will deliver a heat output which varies across the surface of the electrical heater as a sinusoid.

In general the choice of materials used in and the dimensions of an electrical heater will determine the power output per unit area of a particular electrical heater. For example, a thicker heating element will produce a greater heat output for the same current passed through it, due to the larger resistance. However, it will require a larger voltage supplied to it to deliver the same current. A thinner heating element will allow a lower voltage to be used to power the electrical heater than would be required by a similar electrical heater with a thicker heating element and may be appropriate where a lower heat output is required. A further advantage of using a thin heating element is that a thin heating element will be more flexible and formable than a thick heating element. Additionally, a thin heating element will require less raw materials, and therefore be less expensive to manufacture than a thick heating element. The same applies equally to the thickness of ethylene acetate/acrylate elements when operating as temperature regulation elements.

The thickness of each of the heating element and the ethylene acetate/acrylate element may vary between various applications. The thickness of a heating element according to the embodiment shown in FIG. 3 may for example be greater than or equal to 0.1 mm. The thickness of a heating element according to the embodiment shown in FIG. 3 may for example be less than or equal to 20 mm. The thickness of an ethylene acetate/acrylate element may for example be greater than or equal to 0.1 mm. The thickness of an ethylene acetate/acrylate element may for example be less than or equal to 20 mm. In one example, an electrical heater may have a heating element thickness of 2 mm, and an ethylene acetate/acrylate element thickness of 0.5 mm. Such an electrical heater would have an overall thickness of 3 mm.

An ethylene acetate/acrylate element may be fabricated to be as thin as possible while maintaining a uniform thickness. It will be appreciated that any variation in material thickness will affect the resistance of that material layer. In particular, current will flow through a low resistance path in preference to a higher resistance path. As such, any uneven thickness in the heating element or ethylene acetate/acrylate layer may result in uneven heat generation and device performance. While a thin ethylene acetate/acrylate layer may be desirable for a particular application, for example to allow a low operating voltage to be used, a thinner layer will be affected more significantly by a small variation in thickness than a thicker layer. For example, while a layer of 10 mm would be relatively insensitive to a variation in thickness of 0.01 mm, the same variation in thickness would significantly affect the properties of a layer which was 0.1 mm in total thickness. Therefore, the minimum thickness for any particular heating element or ethylene acetate/acrylate element may be limited by the processes which are used to fabricate that part. Where an accurately controlled thickness can be achieved, then a thinner layer can be used. Alternatively, in an application in which precise control of the heating or regulation properties of the electrical heater are not required then a thinner layer can be safely used than would be possible in an application in which precise control of the heating or regulation properties of the electrical heater was required.

In an alternative embodiment, as shown in FIG. 10, an electrical heater 90 may be integrated into a moulded part which performs some other mechanical function. The electrical heater 90 comprises a first conductor 91 which forms the bottom surface of the electrical heater 90, a heating element 92, which comprises an ethylene acetate/acrylate compound, and a second conductor 93, which forms the top surface of the electrical heater 90.

The construction and operation of the electrical heater 90 is similar to that of the electrical heater described with reference to FIG. 2. However, the electrical heater 90 is formed with a plurality of recesses 94. The recesses 94 are shaped to receive fluid carrying conduits. The recesses 94 result in the electrical heater 90 having a thickness A, above the recesses 94 which is less than a thickness B which is not above the recesses 94.

FIG. 10B shows a cross-section view of the electrical heater 90, viewed from the direction indicated by arrows X. The recesses 94 can be seen to connect together within the electrical heater 90. FIG. 100 shows a further side-elevation of the electrical heater 90. A plurality of fluid carrying conduits 95 are shown in the recesses 94. In use the electrical heater 90 may be used to heat the contents of the fluid carrying conduits 95. The electrical heater 90 may also act as a mechanical junction box, allowing different conduits to be joined together.

The electrical heater 90 may be formed by a process of pressing, as described above. A suitably shaped mould is lined with a metal foil, forming the first conductor 91. The void of the mould is then filled with an ethylene acetate/acrylate compound, forming the heating element 92. The second conductor 93 is provided by a second metal foil which is placed upon the ethylene acetate/acrylate compound. Pressure and temperature are applied to the mould as described above to melt the ethylene acetate/acrylate compound, and form a bond between the heating element 92 and the conductors 91, 93.

The electrical heater 90 will output heat differentially in dependence upon its thickness in each region when a voltage is applied between the first conductor 91 and the second conductor 93. In particular, the electrical heater 90 has a reduced thickness A in the regions close to the recesses 94 which will have a smaller resistance than the large thickness B in the regions between the recesses 94. For this reason, more current will flow at A than at B, leading to more heat being produced at A than at B. The non-uniform distribution of heat described above can be used to preferentially heat the contents of the fluid carrying conduits 95, rather than the body of the electrical heater.

The electrical heater 90 could be installed in a location which was exposed to freezing conditions, such as in automotive applications. For example, the electrical heater 90 could be used to deliver fluid to a windscreen washer system. In such a use the fluid contents of the fluid carrying conduits 95 would be prevented from freezing by the heat generated within the heating element 92. The electrical heater 90 could be used in conjunction with heated conduits, such as those shown in FIG. 5, so as to warm fluid passing though fluid carrying conduits 95.

In an embodiment, an electrical heater as shown in FIG. 10 may comprise a heating element which comprises an HDPE compound, and at least one separate temperature regulation element, which comprises an ethylene acetate/acrylate compound. In such an embodiment, either or both of the heating element and/or the ethylene acetate/acrylate element may have a first thickness in a first region and a different thickness in a second region.

The electrical heater illustrated in FIG. 10 provides an example of an embodiment of the invention applied to a mechanical assembly which also performs a function other than that of a heater. The heating element of an electrical heater may be formed so as to have any mechanical structure which performs a mechanical function.

More generally, an electrical heater may have a first thickness in a first region, and a different thickness in a second region, allowing heat to be directed preferentially to a first region. In particular, an electrical heater may have recesses formed within an ethylene acetate/acrylate element or a heating element to allow for interaction with other mechanical components. For example, recesses may be designed to allow fluid carrying conduits to be received within the recesses. In a further example, an electrical heater may have conduits formed within an ethylene acetate/acrylate element or a heating element to allow for fluid to flow within the conduits when connected to an external fluid carrying conduit.

Embodiments of the invention may also comprise regions formed of ethylene acetate/acrylate compound, or any of the materials used to form the ethylene acetate/acrylate element or heating element, which do not function as a temperature regulation element or heating element, but instead perform a solely mechanical function. For example a region of additional ethylene acetate/acrylate compound may be provided which is not between two conductors, and so will not receive any current flowing between conductors. The additional ethylene acetate/acrylate compound will then have no temperature regulating behaviour, or indeed any effect on the electrical performance of the electrical heater. Instead, the additional ethylene acetate/acrylate compound may serve as a mechanical reinforcing member. For example, with reference to the electrical heater shown in FIG. 10, additional ethylene acetate/acrylate compound may be provided below the first conductor 91. The additional ethylene acetate/acrylate compound could itself form a fluid carrying conduit within the electrical heater 90, allowing external fluid carrying conduits to be attached at the boundaries of the electrical heater 90. In this example, the electrical heater could perform the secondary function of a fluid junction box, in addition to that of an electrical heater.

In a further embodiment of the invention, as shown in FIG. 11, an electrical heater 100 is a heating cable having a first conductor 101, a heating element 102 and a second conductor 103. The heating element 102 comprises an ethylene acetate/acrylate compound. The electrical heater 100 has a circular cross section, having an axis at the centre of the circular cross section. The electrical heater 100 is elongate, extending along the axis. Thus, the electrical heater 100 may be in the form of a cable. The first conductor 101 is a solid metal wire having a circular cross-section. The first conductor 101 forms the centre of the electrical heater 100, extending along the length of the electrical heater 100. The heating element 102 surrounds the first conductor 101, and also extends along the length of the electrical heater 100. The second conductor 103 surrounds the heating element 102 (and therefore also first conductor 101), and also extends along the length of the electrical heater 100.

The operation of the electrical heater 100 is similar to that of the electrical heaters described with reference to previously described embodiments of the invention, for example the electrical heater of FIG. 2. In use, a voltage is applied between the first and second conductors 101, 103, causing current to flow between the conductors 101, 103 and through the heating element 102, causing electrical energy to be dissipated as heat.

A continuous process (e.g. extrusion) may be used to fabricate the electrical heater 100. The electrical heater 100 may be assembled in a single extrusion process, the heating element 102 and the second conductor 103 being extruded around the first conductor 101. Alternatively, in a first processing step, the heating element 102 may be extruded around the first conductor 101, and in a second processing step the second conductor 103 may be extruded around the heating element 102.

The application of pressure, and elevation of temperature, present at the die of an extruder provides the conditions required to achieve a good quality bond between the ethylene acetate/acrylate compound and the metal conductors, forming the heating element 102 and the first and second conductors 101, 103.

An extruded electrical heater may be pulled through a further reducing die (either hot or cold) in order to reduce the diameter of the heater. This additional processing step may provide an increased pressure within the heater, causing an improved bond to be formed between the ethylene acetate/acrylate compound and the metal conductors.

The geometry of the various components which form the electrical heater 100 (i.e. the first conductor 101, heating element 102, and second conductor 103) define the output power and performance characteristics of the electrical heater. For example, the output power per unit length of electrical heater 100 will be set by the resistivity of the heating element 102 (which may be a function of temperature), the thickness of the heating element 102, and the width of the heating element 102 (i.e. if the heating element 102 was to be unrolled from around the first conductor 101, it could be considered to have a ‘width’). The thickness of the heating element 102 may be constant (i.e. the separation between the first conductor 101 and the second conductor 102 in a radial direction). However, the area of the heating element 102 which is in contact with the first conductor 101 (i.e. at the circumference of the first conductor 101) will be less than the area of the heating element 102 which is in contact with the second conductor 103 (i.e. at the inner circumference of the second conductor 103). The area is the product of the ‘width’ as described above, and the length along the electrical heater 100. Therefore, the heating element may be considered to have a single effective width which is between the circumference of the first conductor 101 and the inner circumference of the second conductor 103.

Another characteristic of the electrical heater 100 which is influenced by geometry is the resistance of the conductors 101, 103. While in earlier described embodiments of the invention the use of metal foils is discussed, it will be appreciated that thicker metal layers may alternatively be used. This may be particularly appropriate in embodiments which are elongate, for example the electrical heater 50 described with reference to FIG. 6. In such embodiments, thicker metal layers may be used to reduce the resistance of the conductors. In some applications, especially where electrical heaters are required to cover large distances (e.g. oil pipelines, railway lines), voltage drop along the conductors of an electrical heater can severely limit the length of heater which can be deployed, necessitating electrical power supply connections at regular intervals. Reducing the resistance of the conductors reduces the voltage drop along their length allowing fewer electrical connections to be made. This may provide a significant advantage where providing electrical connections is expensive or inconvenient.

For example, in the electrical heater 100, the first conductor 101 may have a cross-sectional area of around 40 mm² (which corresponds to a diameter of ˜7.14 mm). The heating element 102 has a thickness of 2 mm. The inner circumference of the second conductor 103 is ˜11.14 mm. The second conductor 103 has a thickness of around 1.04 mm, and therefore has a cross-sectional area of 40 mm² (i.e. the same as that of the first conductor 101). By providing large cross-section conductors, it is possible to provide an electrical heater which can be deployed in applications which require a long heater length. Large cross-section conductors can be matched (i.e. both the first and second conductors having similar large cross-sections) so as to ensure that a similar voltage drop is experienced by both conductors.

For example, when compared to a conventional heating cable having bus-wires each having a cross-sectional area of around 1.25 mm², a reduction in voltage drop along the length of an electrical heater of approximately an order of magnitude can be brought about by using conductors each having a cross sectional area of 40 mm².

An electrical heater may be designed such that the voltage drop along the length of the electrical heater is less than a predetermined amount. For example, a voltage drop of 10% of the supply voltage may be permitted along the length of a conductor within an electrical heater (i.e. a 10% voltage drop along each of the two conductors, and the remaining 80% of the voltage dropped across the heating element).

For example, a conventional heating cable having copper conductors each having a cross-sectional area of 1.25 mm², and an output power of 30 W/m when supplied with a voltage of 230 V, may extend to around 100 m in length before the voltage across the heating element at the end of the heater distant from the supply is reduced to around 80% of the supply voltage. Conversely, an electrical heater according to an embodiment of the invention having aluminium conductors each having a cross-sectional area of 40 mm², and an output power of 30 W/m when supplied with a voltage of 230 V, may extend to approximately 500 m or more in length before the voltage across the heating element at the end of the heater distant from the supply is reduced to around 80% of the supply voltage. Increasing the cross-sectional area of the conductors may thus allow the length of an electrical heater to be extended significantly.

Conductors having a cross sectional area of at least 10 mm² may be considered large cross-section conductors for the purpose of the invention. Such large cross-section conductors may provide a useful reduction in voltage drop when compared to conventional heating cables having a cross-sectional area of, for example, around 1.25 mm².

The upper limit in useful conductor cross-sectional area may be determined by factors such as material cost, cable weight, or cable flexibility. Conductors having a cross-sectional area of up to around 100 mm² may, for example, provide a useful reduction in voltage drop when compared to conventional heating cables having a cross-sectional area of, for example, around 1.25 mm², while still enabling a cost-effective and useable electrical heater. In some applications conductors with larger cross-sectional areas may be used.

It is appreciated that increasing the cross-sectional area of a conductor within a prior art heating cable would have the effect of reducing the resistance of that conductor, and therefore reducing any voltage drop along the length of that conductor. However, if large cross-section conductors were used in conventional prior art heating cables (for example, the heating cable shown in FIG. 1), this would result in the heating element having to be increased in cross-sectional area so that it would entirely surround the enlarged conductors, so as to ensure contact was maintained between the conductors and the heating element. If the heating element was not enlarged so as to entirely surround the conductors, the poor bond between the conductors and the heating element which is present in known heating cables would cause the conductors to separate from the heating element, losing electrical contact and causing poor electrical performance and reliability of the heating cable.

It will therefore be appreciated that the enhanced bonding brought about by the use of ethylene acetate/acrylate compounds as a component part of electrical heaters, as described above, allows the use of large cross-section conductors in electrical heaters with a wide range of geometries.

The use of the arrangement of FIG. 11 will also ensure that the conductors cannot separate from the heating element, each layer in the device being entirely surrounded by the next layer. Further, the use of the arrangement shown in FIG. 11 allows a smaller overall cross-section to be achieved in heating cables having a given conductor cross-section when compared to conventional heating cables.

In addition to the arrangement shown in FIG. 11, it will be appreciated that large cross-section conductors can also be used in other embodiments of the invention described herein. The thickness of each conductor can be selected for a particular electrical heater taking into account the intended power output of that electrical heater and the desired length of that conductor, so as to mitigate the effect of voltage drop along the length of the conductor. For example, thick metal foils could be used in combination with the electrical heater shown in FIG. 6 to provide an electrical ribbon heater which extended in the y direction for tens or hundreds of metres without suffering from a significant voltage drop.

Similarly, it will be appreciated that additional heating elements or temperature regulation elements, for example as described with reference to FIGS. 3 and 4, can be included in an electrical heater as shown in FIG. 11.

The use of an electrical heater having conductors and a heating element in a circular arrangement, as shown in FIG. 11, allows the electrical heater to be bent in any direction. For example, an electrical heater as shown in FIG. 11 could be wound around a fluid carrying conduit. In such an application, it would be possible to bend the electrical heater around corners in the conduit without having to arrange the electrical heater in a particular plane in which it was able to bend. This can be understood in comparison with the substantially planar electrical heaters shown in FIGS. 2, 3, 4, 6 and 8, which, while able to bend easily in the y-z and x-z planes (depending on the thickness in the z-direction), may be difficult to bend in the x-y plane, because of their planar structure.

A disadvantage of known heating cables is the restriction to a linear cable form factor, such as that shown in FIG. 1. While this form factor is appropriate for some applications, such as for heating conduits, many applications exist where an alternative form factor may be more appropriate. The examples described above demonstrate the flexibility of the use of ethylene acetate/acrylate compounds as a component part of electrical heaters.

1-56. (canceled)

57. An electrical heater comprising;
a first conductor,
a second conductor, and
a heating element, wherein the heating element comprises an electrically conductive material distributed within an ethylene acetate or ethylene acrylate copolymer, and wherein:
the heating element is disposed between the first conductor and the second conductor,
the first conductor, the second conductor and the heating element form a stack, and
the heating element has a first thickness in a first region and a different thickness in a second region.

58. An electrical heater according to claim 57 wherein the electrical heater performs a mechanical function.

59. An electrical heater according to claim 57 wherein the electrical heater comprises a fluid carrying conduit.

60. An electrical heater according to claim 57 wherein the electrical heater is arranged to receive a fluid carrying conduit.

61. An electrical heater according to claim 57 wherein the ethylene acetate or ethylene acrylate copolymer has a gel content of greater than 60% by weight.

62. An electrical heater according to claim 57 wherein the first conductor and the second conductor are formed from metal foils.

63. An electrical heater according to claim 57 wherein the electrically conductive material comprises conductive particles.

64. An electrical heater according to claim 57 wherein the heating element further comprises a second electrically insulating material.

65. A method of manufacturing an electrical heater, the electrical heater comprising a first conductor, an ethylene acetate or ethylene acrylate compound, and a second conductor arranged in a stack, the ethylene acetate or ethylene acrylate compound comprising an electrically conductive material distributed within an ethylene acetate or ethylene acrylate copolymer and being disposed between the first conductor and the second conductor, the method comprising;
raising the temperature of the ethylene acetate or ethylene acrylate compound so as to melt the ethylene acetate or ethylene acrylate compound;
applying force to the first conductor and the ethylene acetate or ethylene acrylate compound so as to force substantially all of the air from between the first conductor and the ethylene acetate or ethylene acrylate compound and from within the ethylene acetate or ethylene acrylate compound; and
cooling the ethylene acetate or ethylene acrylate compound to ambient temperature such that, when cooled, the ethylene acetate or ethylene acrylate compound is arranged to form an ethylene acetate or ethylene acrylate element and is bonded to the first conductor.

66. A method of manufacturing an electrical heater according to claim 65, the method further comprising:
providing a heating element compound, the heating element compound comprising a second electrically conductive material distributed within an electrically insulating material, wherein the heating element compound is disposed between the second conductor and the ethylene acetate or ethylene acrylate element,
raising the temperature of the heating element compound so as to melt the heating element compound;
applying force to the ethylene acetate or ethylene acrylate compound and the heating element compound so as to force substantially all of the air from between the ethylene acetate or ethylene acrylate compound and the heating element compound and from within the heating element compound; and
cooling the heating element compound to a temperature below the melting point of the heating element compound such that, when cooled, the heating element compound is arranged to form a heating element.

67. A method of manufacturing an electrical heater according to claim 66, the method further comprising:
providing a second ethylene acetate or ethylene acrylate compound, the second ethylene acetate or ethylene acrylate compound comprising an third electrically conductive material distributed within a second ethylene acetate or ethylene acrylate copolymer; wherein the second ethylene acetate or ethylene acrylate compound is disposed between the heating element compound and the second conductor;
raising the temperature of the second ethylene acetate or ethylene acrylate compound so as to melt the second ethylene acetate or ethylene acrylate compound;
applying force to the heating element compound, the second ethylene acetate or ethylene acrylate compound, and the second conductor so as to force substantially all of the air from between the heating element compound and the second ethylene acetate or ethylene acrylate compound, and the second ethylene acetate or ethylene acrylate compound and the second conductor and from within the second ethylene acetate or ethylene acrylate compound; and
cooling the second ethylene acetate or ethylene acrylate compound to a temperature below the melting point of the second ethylene acetate or ethylene acrylate compound such that, when cooled, the second ethylene acetate or ethylene acrylate compound is arranged to form a second ethylene acetate or ethylene acrylate element and is bonded to the second conductor.

68. A method of manufacturing an electrical heater, the electrical heater comprising a first conductor, an ethylene acetate or ethylene acrylate compound, and a second conductor arranged in a stack, the ethylene acetate or ethylene acrylate compound comprising an electrically conductive material distributed within an ethylene acetate or ethylene acrylate copolymer and being disposed between the first conductor and the second conductor, the method comprising;
raising the temperature of the ethylene acetate or ethylene acrylate compound so as to melt the ethylene acetate or ethylene acrylate compound;
applying force to the first conductor, the second conductor, and the ethylene acetate or ethylene acrylate compound so as to force substantially all of the air from between the first conductor and the ethylene acetate or ethylene acrylate compound, and the ethylene acetate or ethylene acrylate compound and the second conductor and from within the ethylene acetate or ethylene acrylate compound; and
cooling the ethylene acetate or ethylene acrylate compound to ambient temperature such that, when cooled, the ethylene acetate or ethylene acrylate compound is arranged to form an ethylene acetate or ethylene acrylate element and is bonded to the first conductor and the second conductor.

69. A method of manufacturing an electrical heater according to claim 65 wherein the method is a continuous process.

70. A method of manufacturing an electrical heater according to claim 65 wherein force is applied at least partially by extrusion through a die.

71. A method of manufacturing an electrical heater according to claim 65 wherein force is applied at least partially by rollers.

72. A method of manufacturing an electrical heater according to claim 65, wherein applying force to the first conductor and the ethylene acetate or ethylene acrylate compound comprises:
applying a first force to the ethylene acetate or ethylene acrylate compound so as to force substantially all of the air from within the ethylene acetate or ethylene acrylate compound; and
applying a second force to the first conductor and the ethylene acetate or ethylene acrylate compound so as to force substantially all of the air from between the first conductor and the ethylene acetate or ethylene acrylate compound.

73. A method of manufacturing an electrical heater according to claim 72, wherein the first force is applied by extrusion through a die.

74. A method of manufacturing an electrical heater according to claim 72, wherein the second force is applied by rollers.

75. A method of manufacturing an electrical heater according to claim 65 further comprising irradiating the ethylene acetate or ethylene acrylate element with an electron beam.

76. A method of manufacturing an electrical heater according to claim 65 wherein the electrical heater is irradiated with a dosage of at least 50 kilograys of electron beam radiation.
